(19) United States
(12) Patent Application Publication
(10) Pub. No.: US 2026/0323240 A1
(43) Pub. Date: Oct. 15, 2026

(54) Direction-Aware Neural Acoustic Field for Spatially Resolved Room Impulse Response Modeling

(71) Applicant: Mitsubishi Electric Research Laboratories, Inc., Cambridge, MA (US)

(72) Inventors: Gordon Wichern, Boston, MA (US); Christopher Ick, New York, NY (US); Yoshiki Masuyama, Somerville, MA (US); François G Germain, Quincy, MA (US); Jonathan Le Roux, Arlington, MA (US)

(73) Assignee: Mitsubishi Electric Research Laboratories, Inc., Cambridge, MA (US)

(21) Appl. No.: 19/237,961

(22) Filed: Jun. 13, 2025

Related U.S. Application Data
(60) Provisional application No. 63/786,432, filed on Apr. 10, 2025.

(51) Int. Cl. H04S 7/00; G06T 19/00; H04R 5/033; H04S 3/00

(52) U.S. Cl. CPC H04S 7/306; G06T 19/006; H04R 5/033; H04S 3/004; H04S 2420/01; H04S 2420/11

(57) ABSTRACT

An audio system and method are disclosed for performing spatial audio tasks using direction-aware neural modeling of room impulse responses (RIRs). The audio system includes a direction-aware neural acoustic field (DANF) module that is configured to receive a spatial configuration comprising a position of an acoustic source, a position of a listener, and an orientation of the listener within a three-dimensional environment. The DANF module is also configured to generate an Ambisonic-format RIR representing directionally resolved acoustic energy. An audio processing module is operatively coupled to the DANF module and is configured to perform an audio task—such as rendering, synthesis, or localization—based on the Ambisonic-format RIR. The use of Ambisonic representation enables consistent directional encoding, and the neural field architecture supports flexible and efficient spatial modeling for immersive audio applications.

### TECHNICAL FIELD

The present disclosure generally relates to spatial audio signal processing and machine learning. More particularly, it pertains to systems and methods for generating directionally resolved room impulse responses using neural fields trained with directional supervision, such as intensity vector loss.

### BACKGROUND

Accurately modeling how sound propagates through an acoustic environment is essential for high-fidelity spatial audio applications. This modeling is typically achieved using room impulse responses (RIRs), which characterize the time-domain behavior of sound as it travels from a source to a listener within a space. RIRs can be measured using specialized microphones or simulated based on the physical geometry and materials of the environment.

Traditional approaches for RIR modeling often rely on geometric acoustics or wave-based simulations, which can be computationally expensive and require detailed knowledge of the environment. More recently, neural acoustic fields (NAFs)—neural network models trained to interpolate RIRs across continuous spatial positions—have emerged as a data-driven alternative. These models enable efficient estimation of RIRs for arbitrary source-listener pairs, based on limited measurements.

However, existing neural field-based approaches to room impulse response modeling often focus on simplified signal representations that do not fully capture the directional complexity of acoustic fields. As a result, these models may fall short in applications that demand high spatial fidelity, such as immersive audio rendering, source localization, or spatial audio synthesis.

Attempts to infer directional information from such models through secondary processing techniques have shown limited success, often yielding results that are inconsistent or sensitive to noise. In addition, adapting these models to new acoustic environments can be computationally burdensome and data-intensive, making them less suitable for scenarios where flexibility and scalability are important.

Accordingly, there remains a need for improved techniques in neural acoustic modeling that can overcome the challenges mentioned above.

### SUMMARY

The present disclosure provides systems and methods that can more effectively capture spatial acoustic characteristics, provide reliable directional information, and adapt efficiently across diverse environments.

The present disclosure relates to systems and methods for spatial audio processing using machine-learned models that generate directionally resolved representations of room impulse responses (RIRs). More particularly, it is an object of some embodiments to disclose a direction-aware neural acoustic field (DANF) framework that enables spatially accurate and perceptually consistent audio rendering in three-dimensional environments.

In many spatial audio applications—such as virtual or augmented reality (VR/AR), telepresence, and sound source localization—the directional characteristics of sound propagation are beneficial for delivering immersive and accurate auditory experiences. However, existing neural acoustic field approaches often lack explicit modeling of directional acoustic energy, limiting their ability to generalize across spatial configurations and accurately reproduce direction-of-arrival (DoA) cues.

The characteristics of a sound field are intrinsically linked to the geometric and spatial properties of the environment surrounding a sound source and a listener. Inferring how an acoustic signal emitted from a sound source is received by a listener involves modeling the physically complex propagation of that signal through their shared environment. Even when the source and listener are in direct line-of-sight, reflections of the sound signal at various surfaces and objects add significant contributions to what the listener hears. Precisely capturing the acoustic properties of this process, which is typically done in the RIR to be convolved with a dry signal at the source, is crucial for accurate sound rendering, which in turn enables immersive experiences in media, particularly in virtual and augmented reality. In order to convincingly explore a space in a virtual reality environment, the RIRs must be accurately modeled at all possible source-listener locations.

Because the process of recording RIRs can be time-consuming and impractical in certain settings, there exists a broad set of methods for simulating RIRs, typically either by geometric acoustic methods or directly approximating the solution to the wave equation for sound propagation. However, these methods are computationally intensive and require an accurate geometric and material specification of a given scene to produce accurate RIRs.

Prior work using neural acoustic fields (NAFs) has allowed learning spatially continuous representations of RIRs from finite RIR measurements. However, previous NAF-based methods have focused on monaural omnidirectional or at most binaural listeners, which does not precisely capture the directional characteristics of a real sound field at a single point. These previous neural field methods focus exclusively on omnidirectional microphones and synthesize either monaural or stereo/binaural audio signals. However, these approaches fail to account for precise listener orientation and inter-channel directional information which are crucial for delivering immersive audio experiences in mixed reality applications where the audio is output by a large number of speakers. Furthermore, estimating RIRs with precise directional information is also especially useful for downstream tasks such as event localization.

To that end the DANF framework disclosed in some embodiments, more explicitly incorporates the directional information available in Ambisonic-format RIRs. The DANF framework is used in conjunction with a direction-aware loss, and use of low-rank adaptation techniques to adapt to new rooms.

Some embodiments disclose a system based on a neural field architecture trained to estimate Ambisonic-format RIRs, which encode multichannel directional sound energy using spherical harmonic components. The system receives as input a spatial configuration comprising the position and orientation of the listener, the position of the sound source, and optional environmental context (e.g., room geometry). The system outputs a multi-channel Ambisonic RIR consistent with the spatial configuration.

In some embodiments, the system further enhances directional accuracy by employing a direction-aware loss function based on intensity vectors derived from the Ambisonic RIR channels. This loss guides the system to produce directionally coherent responses by aligning the predicted intensity vectors with those derived from ground truth. Compared to other losses that focus on waveform similarity alone, the intensity vector loss provides a robust, physically grounded signal that improves DoA estimation, inter-channel coherence, and spatial realism, especially in reverberant or data-scarce conditions.

In addition, to support adaptability to new environments, one embodiment incorporates low-rank adaptation techniques that enable few-shot fine-tuning of the system using only a small number of measured RIRs. By conditioning the system on geometric features of the room—such as sampled surface points that represent reflective boundaries (referred to as bounce points) the system can generalize to previously unseen acoustic environments without complete retraining.

Accordingly, the disclosed embodiments enable a flexible, data-efficient, and directionally accurate framework for spatial audio modeling, supporting a range of tasks including spatial rendering, acoustic simulation, DoA estimation, and machine learning data generation in 3D audio environments.

According to one embodiment an audio system for performing an audio task based on spatial modeling of audio signals is provided. The audio system comprises a processor; and a memory storing instructions which, when executed by the processor, configure the audio system to perform the audio task using a plurality of software modules. The plurality of software modules include a direction-aware neural acoustic field module trained to receive as input, a spatial configuration. The spatial configuration is indicative of at least: a position of an acoustic source, a position of a listener, and an orientation of the listener within a three-dimensional environment. The direction-aware neural acoustic field module is configured to generate, based on the spatial configuration, an Ambisonic-format room impulse response (RIR) comprising a plurality of components indicative of directionally resolved acoustic energy. The audio system further includes an audio processing module operatively coupled to the direction-aware neural acoustic field module; the audio processing module being configured to perform the audio task based on the Ambisonic RIR.

According to another embodiment, a computer-implemented method for performing an audio task based on spatial modeling of audio signals is provided. The method comprises receiving, as input, a spatial configuration indicative of at least a position of an acoustic source, a position of a listener, and an orientation of the listener within a three-dimensional environment. The method further includes generating, based on the spatial configuration, an Ambisonic-format room impulse response (RIR) comprising a plurality of components indicative of directionally resolved acoustic energy. Additionally, the method includes performing the audio task based on the Ambisonic RIR.

### BRIEF DESCRIPTION OF THE DRAWINGS

The drawings described herein are provided to illustrate various embodiments of the disclosed system and method for direction-aware neural acoustic field modeling. The drawings are not necessarily to scale.

FIG. 1 is a schematic diagram illustrating a neural acoustic field (NAF) system trained to output monaural RIR.

FIG. 2 illustrates a schematic diagram showing an architecture of a direction-aware NAF system configured to generate an Ambisonic-format RIR, according to an embodiment of the present disclosure.

FIG. 3A is a block diagram illustrating an audio system based on a direction-aware neural acoustic field module, according to an embodiment of the present disclosure.

FIG. 3B is a flow diagram of a method executed by the audio system based on a direction-aware neural acoustic field module, according to an embodiment of the present disclosure.

FIG. 3C is a schematic diagram showing the Ambisonic-format RIR output representation, according to an embodiment of the present disclosure.

FIG. 4 is a schematic diagram illustrating a spatial configuration within a three-dimensional environment, according to an embodiment of the present disclosure.

FIG. 5A is a schematic diagram of the architecture of the DANF module, according to an embodiment of the present disclosure.

FIG. 5B is a block diagram illustrating an end-to-end pipeline of operations performed by the audio system, from spatial configuration input through Ambisonic rendering to downstream audio task execution, according to an embodiment of the present disclosure.

FIG. 6A is a schematic diagram showing an example of an acoustic environment, according to an embodiment of the present disclosure.

FIG. 6B is a schematic diagram illustrating role of bounce points as geometric context of the acoustic environment, according to an embodiment of the present disclosure.

FIG. 7 illustrates a schematic diagram showing an example implementation of various modules of the audio system producing Ambisonic-format RIR, according to an embodiment of the present disclosure.

FIG. 8 is a flowchart illustrating a pipeline of the intensity vector loss calculation, according to an embodiment of the present disclosure.

FIG. 9 illustrates a schematic diagram showing training process of the DANF module, according to an embodiment of the present disclosure.

FIG. 10 illustrates a flowchart of a method for a low-rank adaptation (LoRA) mechanism that enables few-shot adaptation of the DANF module to new environments using lightweight parameter updates, according to an embodiment of the present disclosure.

FIG. 11 illustrates a schematic of an audio processing pipeline configured to generate a spatialized Ambisonic audio signal and perform an audio task based on the spatialized signal, according to some embodiments of the present disclosure.

FIG. 12 illustrates a schematic diagram showing an audio task performed by the audio system for rendering VR/AR audio scenes to a headset by decoding a spatialized Ambisonic signal into a binaural signal using an HRTF aligned with the listener's head orientation, according to an embodiment of the present disclosure.

FIG. 13 illustrates a schematic diagram showing a dynamic update of a binaural audio signal in real time based on changes in the position and/or orientation of the listener, according to some embodiments of the present disclosure.

FIG. 14 illustrates a schematic diagram for acoustic scene simulation, according to some embodiments of the present disclosure.

FIG. 15 illustrates a schematic diagram of the audio system configured to perform the audio task comprising direction-aware speech enhancement or separation, according to some embodiments of the present disclosure.

FIG. 16 illustrates a schematic diagram of an audio system configured to perform an audio task comprising the generation of training data for machine learning models, according to some embodiments.

FIG. 17 illustrates a representative computing device suitable for implementing the direction-aware neural acoustic field system and its associated processes and modules, according to an embodiment of the present disclosure.

FIG. 18A and FIG. 18B illustrate schematic diagrams showing an operational example of an audio task performed by the audio system, according to an embodiment of the present disclosure.

FIG. 19 illustrates an operational example for the audio system, according to an embodiment of the present disclosure.

FIG. 20 illustrates an operational example of an audio task of sound source localization performed by the audio system, according to an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Acoustic signal processing by audio systems involves inferring how an acoustic signal emitted from a sound source is received by a listener. This in turn involves modeling the physically complex propagation of that acoustic signal through their shared environment. Even when the source and the listener are in direct line-of-sight, reflections of the sound signal at various surfaces and objects add significant contributions to what the listener hears. Precisely capturing the acoustic properties of this process, which is typically done in the form of an RIR to be convolved with a dry signal at the source, is crucial for accurate sound rendering, which in turn enables immersive experiences in media, particularly in virtual and augmented reality. In order to convincingly explore a space in a virtual reality environment, the RIRs must be accurately modeled at all possible source-listener locations.

Because the process of recording RIRs can be time-consuming and impractical in certain settings, there exists a broad set of methods for simulating RIRs, typically either by geometric acoustic methods or directly approximating the solution to the wave equation for sound propagation. However, these methods are computationally intensive and require an accurate geometric and material specification of a given scene to produce accurate RIRs. Recently, machine learning approaches based on neural fields (NFs) and physics-informed neural networks that can interpolate RIRs at continuous source and listener positions in a space, using only a small number of measured RIRs and the geometry of the room as model inputs have been proposed. These previous neural field methods focus exclusively on omnidirectional microphones and synthesize either monaural or stereo/binaural audio signals. However, these approaches fail to account for precise listener orientation and inter-channel directional information which are crucial for delivering immersive audio experiences in mixed reality applications where the audio is output by a large number of speakers. Furthermore, estimating RIRs with precise directional information is also especially useful for downstream tasks such as event localization.

A popular approach to capturing a sound field at a point with directional information is to encode it into an Ambisonics format. Ambisonics captures the local pressure gradient vector by projecting it on the basis of spherical harmonics up to a given order n, with the increasing order corresponding to harmonics of increasing spatial resolution. The number of harmonics, and corresponding encoding channels, needed to go up to order n is (n+1)², meaning the popular first-order Ambisonics (FOA) encoding features 4 channels: one omnidirectional channel (w) and 3 figure-of-8 channels aligned with any 3 Cartesian directions (typically referred to as x, y, and z). The use of Ambisonic format RIR with neural fields, may help in achieving a direction-aware neural acoustic field (NAF) that can provide high quality rendering required by immersive audio experiences and related applications, as will be described by various embodiments disclosed herein.

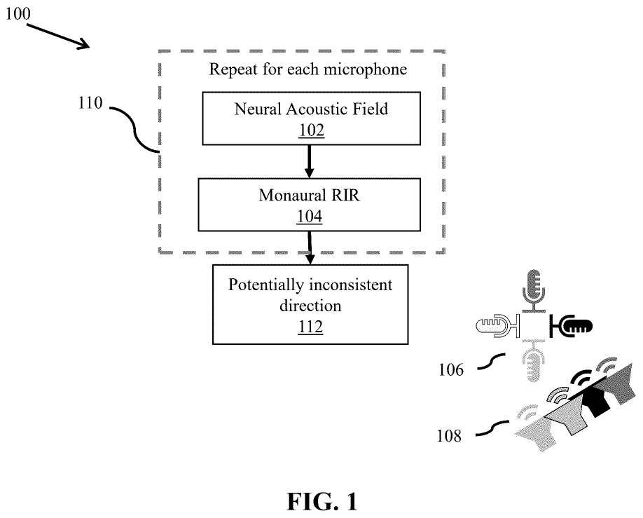

FIG. 1 is a schematic diagram 100 illustrating a neural acoustic field (NAF) system 102 trained to output Monaural RIR 104.

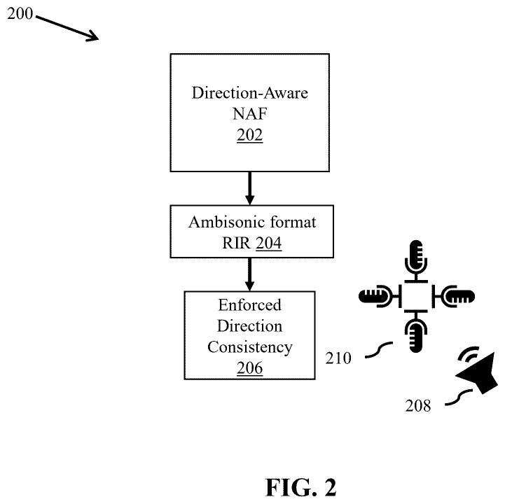

As shown in the schematic 100 of FIG. 1, the NAF system 102 may be configured to estimate the monaural RIR 104 or in some cases binaural RIRs. But simulating RIRs for a large number of directional microphones 106, often requires repeating a single channel model 110 of the NAF system 102 producing the monaural RIR 104 multiple times, which in practice produces a potentially inconsistent direction 112 estimate of the resulting acoustic field. This is because the single channel model 110 does not preserve directional structure in the resulting acoustic field, and this will cause every directional microphone 106 to have potentially inconsistent sound source positions 108. The NAF system 102 may then be used to infer directional information—such as the direction-of-arrival (DoA) of a sound source—through post-processing techniques. The post-processing techniques may include the derivation of acoustic intensity vectors or beamforming operations based on limited directional cues. However, such post hoc inference is frequently unstable and prone to noise, especially in highly reverberant environments or in scenes with sparse RIR measurements. As a result, applications that rely on accurate spatial representation—such as virtual or augmented reality (VR/AR) audio rendering, telepresence, or sound source localization—may experience degraded performance when using direction-agnostic RIR outputs of the NAF system 102. To overcome this shortcomings, the present disclosure proposes a system architecture for a direction aware NAF, which is discussed further in FIG. 2.

FIG. 2 illustrates a schematic diagram 200 showing an architecture of a direction-aware NAF system 202, that is trained to directly generate an Ambisonic-format RIR 204, according to an embodiment of the present disclosure.

The Ambisonic format RIR 204 may include such as a first-order Ambisonic (FOA) representation. Ambisonics provide functions and relational expressions that help in capturing a sound field at a point in the form of an encoding of an audio signal in an Ambisonic format. The Ambisonic format is a set of functions that capture the local pressure gradient vector (of the sound field) by projecting it on the basis of spherical harmonics up to a given order n, with the increasing order corresponding to harmonics of increasing spatial resolution. The number of harmonics, and corresponding encoding channels, needed to go up to order n is (n+1)², meaning the popular first-order Ambisonics (FOA) encoding features 4 channels: one omnidirectional channel (w) and 3 figure-of-8 channels aligned with any 3 Cartesian directions (typically referred to as x, y, and z). The use of the Ambisonic format-RIR 204 with the direction aware NAF system 202, may help in achieving an enforced direction consistency 206 between simulation 208 of audio signals received from a microphone 210 or a series of microphones (referred interchangeably to mean the same). Because the NAF produces an ambisonics format RIR, it ensures that each of the microphone channels have consistent directional information form the sound source position 208. Thus, the direction-aware NAF system 202 provides high quality rendering required by immersive audio experiences and related applications in accordance with various embodiments disclosed herein.

In some embodiments, the direction-aware NAF system 202 receives as input a spatial configuration, which may include one or more of a source position, a listener position, a listener orientation, and optionally an environmental context (e.g., room geometry, bounce points). The direction-aware NAF system 202 outputs a multichannel RIR in the form of the ambisonics-format RIR 204 that includes directional components, such as the W (omnidirectional), X, Y, and Z (figure-of-eight directional) channels of FOA.

By representing the RIR in an Ambisonic basis, the direction-aware NAF system 202 preserves directionality natively in the output, enabling consistent spatial audio reproduction across orientations and spatial locations. Moreover, in some embodiments, the direction-aware NAF system 202 may be trained with a direction-aware loss function, such as one based on time-frequency intensity vectors. This loss function may guide the model to enforce spatial coherence and alignment with reference directional energy distributions, resulting in enhanced DoA estimation and improved perceptual quality of rendered audio.

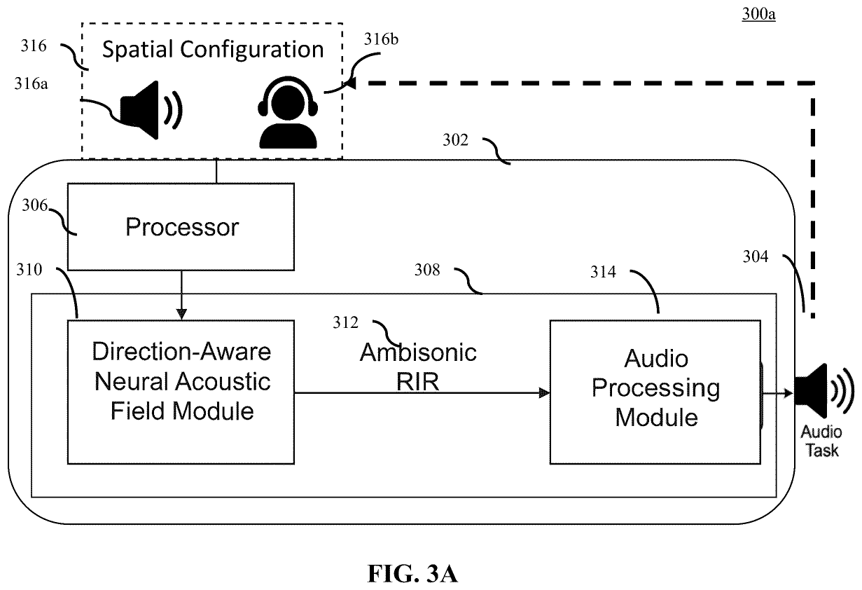

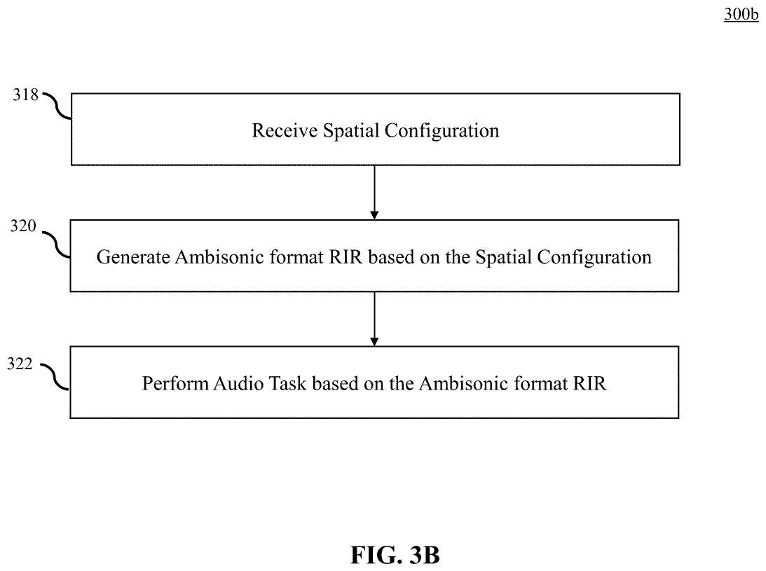

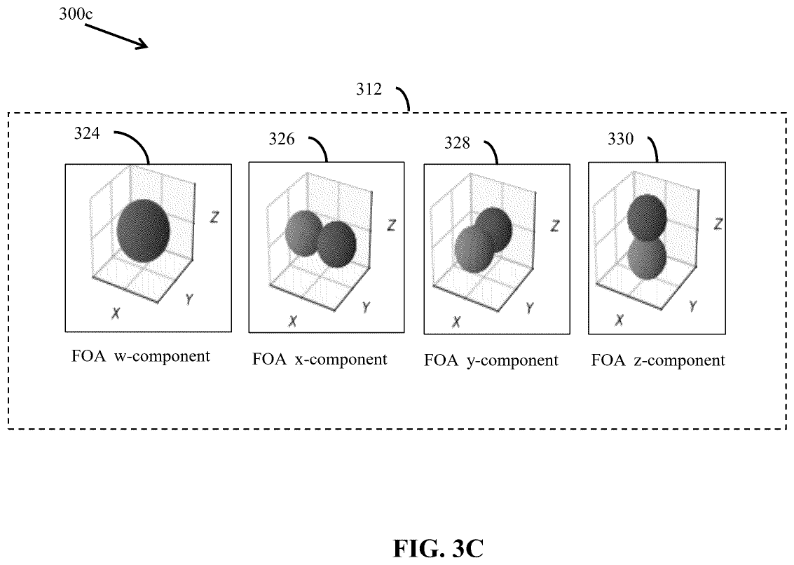

Accordingly, FIG. 3A is a block diagram 300a illustrating an audio system 302 based on a direction-aware neural acoustic field (DANF) module 310, according to an embodiment of the present disclosure. FIG. 3A is explained in conjunction with elements from FIG. 2. To that end, the DANF module 310 may be equivalent to the direction-aware NAF system 202 disclosed in FIG. 2 earlier.

The audio system 302 is configured for performing an audio task 304 based on spatial modeling of audio signals. The audio task 304 may include immersive audio rendering, AR/VR applications, and the like. The audio system 302 includes a processor 306 and a memory 308 storing instructions. The instructions are executed by the processor 306 to configure the audio system 302 to perform the audio task 304 using a plurality of software modules. In certain embodiments, a “module” refers to a computational component configured to perform one or more functions, and may be implemented in software, hardware, firmware, or any combination thereof. A module may include, by way of example and not limitation, a rule-based system, a statistical model, a machine-learned model, or a neural network such as a feedforward network, convolutional neural network (CNN), recurrent neural network (RNN), or transformer. A module may be trained or configured to receive input data and generate output data, and may include associated pre-processing, post-processing, or control logic. Modules may be executed by one or more processors, such as by the processor 306, from instructions stored on a non-transitory computer-readable medium, such as the memory 308 and may operate locally or remotely.

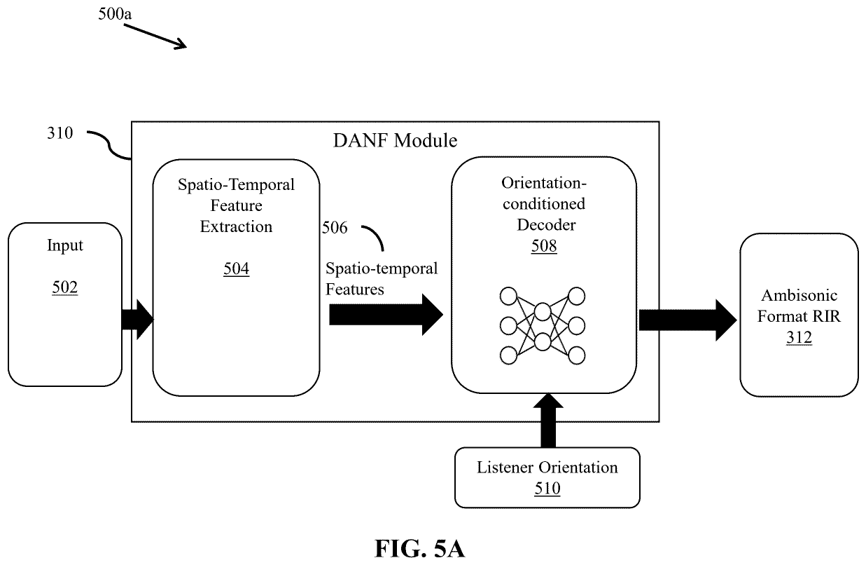

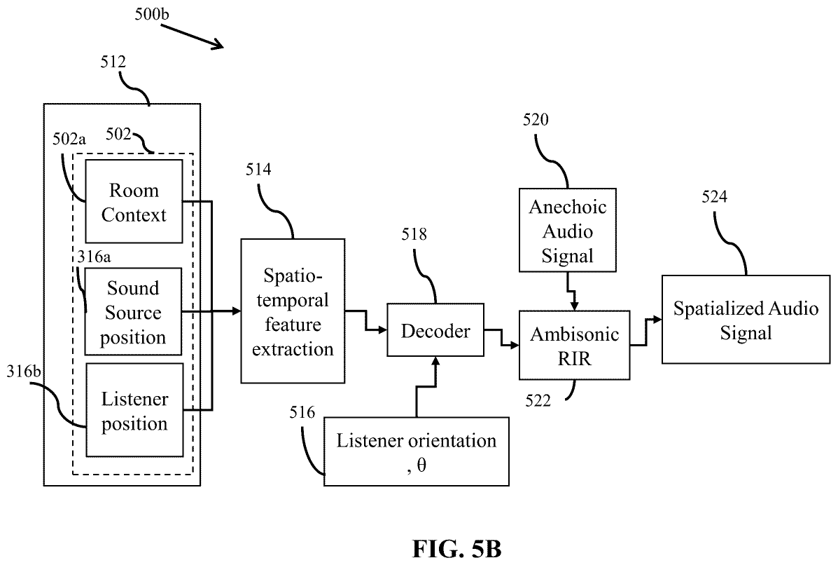

The plurality of software modules include the DANF module 310. The DANF module 310 may comprise or be embodied as a direction-aware neural acoustic field module trained, via the processor 306, to receive as input, a spatial configuration 316. The spatial configuration 316 includes data or information that may be indicative of different types of information including, but not limited to, a position of an acoustic source 316a, a position of a listener 316b, and an orientation of the listener 316b within a three-dimensional environment. Upon receiving the spatial configuration 316, the DANF module 310 causes the processor 306 to execute stored instructions to cause generation of an Ambisonic-format room impulse response (RIR) 312 based on the spatial configuration 316. The DANF module 310 first extracts features based on the input spatial configuration and then decodes these features into an Ambisonic format RIR 312. The Ambisonic-format RIR 312 includes a plurality of components indicative of directionally resolved acoustic energy. The details of the Ambisonic-format RIR 312 generation process are provided further in conjunction with FIG. 5.

The Ambisonic-format RIR 312 is transmitted to an audio processing module 314 which is operatively coupled to the DANF module 310. The audio processing module 314 is configured to perform the audio task based on the Ambisonic-format RIR 312. To that end, the output of the DANF module 310 is the Ambisonic-format RIR 312 encoded in first-order Ambisonics (FOA) format. In an embodiment, this output is a multichannel signal represented by a four-dimensional vector:

$$h ( t ) = [ W ( t ) , X ( t ) , Y ( t ) , Z ( t ) ] ,$$

where t is the time index, and W(t), X(t), Y(t), and Z(t) are the time-domain components of the Ambisonic-format RIR 312, which would be explained further in FIG. 3C. The complete Ambisonic-format RIR 312 r(t) captures both the magnitude and directionality of the acoustic energy arriving at the listener's position. This multichannel format provides a listener-centric, orientation-aware encoding of the sound field, enabling downstream processing by the audio processing module 314 for immersive spatial rendering. In contrast to conventional monaural or binaural RIRs, which only approximate spatial effects, the Ambisonic-format RIR 312 explicitly encodes the local spatial pressure gradient and supports transformation into other spatial audio formats (e.g., binaural playback via head-related transfer functions). Moreover, because the FOA representation is based on spherical harmonic decomposition, it is inherently rotation-equivariant—allowing real-time adaptation of the rendered signal to changes in listener orientation. Thus, the use of direction-aware neural fields of the DANF module 310 trained to output the Ambisonic-format RIRs offer inherent advantages in spatial accuracy and robustness compared to direction-agnostic systems, supporting a broad range of spatial audio task(s) 304 by the audio system 302.

In an embodiment, the audio system 302 is configured via the processor 306 to execute a computer-implemented method in the form of stored instructions describing various steps of the computer-implemented method, which enable the audio system 302 to perform the audio processing task 304. An example of such computer-implemented method is provided in FIG. 3B.

FIG. 3B is a flow diagram of a computer-implemented method 300b executed by the audio system 302 based on the DANF module 310, according to an embodiment of the present disclosure. FIG. 3B is explained in conjunction with elements from FIG. 2 and FIG. 3A. The computer-implemented method 300b may be implemented, for example, by one or more hardware or software components operating individually or collectively. For example, the processor 306 shown in FIG. 3A may conduct steps of the computer-implemented method 300b shown in FIG. 3B.

The computer-implemented method 300b includes various steps that enable the audio system 302 to perform the audio task 304 based on spatial modeling of audio signals. At step 318 of the computer-implemented method 300b, the audio system 302 is configured to receive, as input, the spatial configuration 316 indicative of at least the position of an acoustic source 316a, the position of the listener 316b, and the orientation of the listener 316b, within the three-dimensional environment.

At step 320 of the computer-implemented method 300b, the audio system 302 is configured to generate, based on the spatial configuration 316, the Ambisonic-format RIR 312 h(t) which includes a plurality of components indicative of directionally-resolved acoustic energy, such as in the form of the time-domain components W(t), X(t), Y(t), and Z(t), which are shown in FIG. 3C.

FIG. 3C illustrates a schematic diagram 300c showing the Ambisonic-format RIR 312 output representation generated by the DANF module 310, according to an embodiment of the present disclosure.

As shown in FIG. 3C, the output of the DANF module 310 is the Ambisonic-format RIR 312 encoded in first-order Ambisonics (FOA) format. The Ambisonic-format RIR 312 is a multi-channel RIR that is encoded using a plurality of spherical harmonic components corresponding to spatially distinct directions. More specifically, the Ambisonic-format RIR 312, h(t), is encoded using the FOA format in the form of a multichannel signal represented by a four-dimensional vector, the four dimensions corresponding to spatially distinct directions, as:

$$h ( t ) = [ W ( t ) , X ( t ) , Y ( t ) , Z ( t ) ] ,$$

where t is the time index, and W(t), X(t), Y(t), and Z(t) are the time-domain components of the Ambisonic-format RIR 312. Specifically:
W(t) represents a first FOA w-component 324 corresponding to the omnidirectional pressure component, corresponding to the zeroth-order spherical harmonic (monopole);
X(t), Y(t), Z(t) represent, respectively, a second FOA x-component 326, a third FOA y-component 328, and a fourth FOA z-component 330, corresponding to the directional figure-of-eight components, aligned with the Cartesian axes (typically left-right, up-down, and front-back), corresponding to the first-order spherical harmonics.

To that end, the Ambisonic-format RIR 312 h(t) corresponds to a B-format representation. B-Format is a standardized representation of sound used in Ambisonics. B-Format is the intermediate representation of the Ambisonics sound field. It consists of a set of audio signals (channels), each corresponding to a spherical harmonic component of the sound field. At FOA, the B-Format has 4 channels:

The first FOA w-component 324, W(t), is the omnidirectional channel which corresponds to pressure variations due to sound field, and is like a mono mic.

The second FOA x-component 326, X(t), is the directional figure-of-eight component aligned with left-right direction of Cartesian axes.

The third FOA y-component 328, Y(t), is the directional figure-of-eight component aligned with up-down direction of Cartesian axes.

The fourth FOA z-component 330, Z(t), is the directional figure-of-eight component aligned with the front-back direction of Cartesian axes

Each component W(t), X(t), Y(t), Z(t) is modeled as a separate channel in the FOA output, and the complete Ambisonic-format RIR 312 h(t) captures both the magnitude and directionality of the acoustic energy arriving at the listener's 316b position. This multichannel format provides a listener-centric, orientation-aware encoding the sound field, enabling downstream processing for immersive spatial rendering.

In contrast to conventional monaural or binaural RIRs, which only approximate spatial effects, the Ambisonic-format RIR 312 explicitly encodes the local spatial pressure gradient and supports transformation into other spatial audio formats (e.g., binaural playback via head-related transfer functions). Moreover, because the FOA representation is based on spherical harmonic decomposition, it is inherently rotation-equivariant—allowing real-time adaptation of the rendered signal to changes in listener orientation.

Additionally, the Ambisonic-format RIR 312 is structured and multichannel in nature making it highly beneficial for high-fidelity, directionally consistent spatial audio processing.

Returning back to the method 300b of FIG. 3B, the Ambisonic-format RIR 312 is then submitted to the audio processing module 314.

At step 322 of the computer-implemented method 300b, the audio system 302 is configured to perform the audio task 304 based on the Ambisonic-format RIR 312.

It may be understood that the computer-implemented method 300b may continue with additional steps as illustrated and described. In some embodiments, one or more of the steps may be omitted, repeated, and/or performed in a different order than that shown without departing from the scope of the disclosure. Furthermore, although the computer-implemented method 300b is described in a particular sequence, it is understood that the order of operations may vary depending on the implementation.

The functionality of the various modules described in FIG. 3A, FIG. 3B and FIG. 3C will now be described in detail in the following figures.

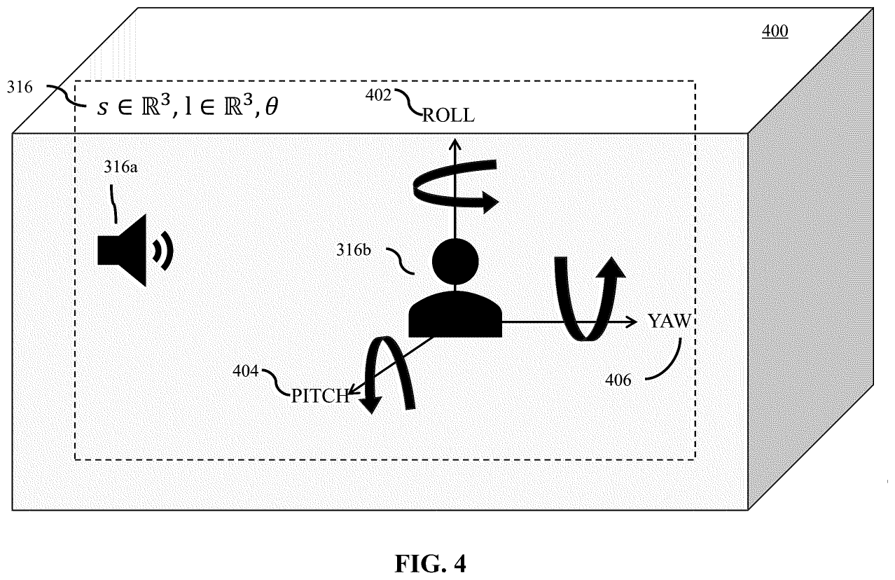

FIG. 4 is a schematic diagram illustrating the spatial configuration 316 within a three-dimensional environment 400, according to an embodiment of the present disclosure. FIG. 4 is explained in conjunction with elements from FIG. 3A, FIG. 3B, and FIG. 3C. The three-dimensional environment 400 may correspond to any of a room, an AR/VR scene, a hall, an auditorium, and the like. The three-dimensional environment 400 may include the positions of the sound source 316a, s∈ [symbol] ³, positions of the listener 316b, l∈ [symbol] ³, as well as the listener's 316b orientation, θ∈[0,2π), which collectively serve as input to the DANF module 310 shown in FIG. 3A in the form of the spatial configuration 316.

Thus, the spatial configuration 316 comprises a source position vector, s∈ [symbol] ³ representing the three-dimensional coordinates of the sound source 316a within an acoustic environment, such as the three-dimensional environment 400, and a listener position vector, l∈ [symbol] ³, representing the coordinates of the listening point or the listener 316b. Additionally, the spatial configuration 316 may include a listener orientation vector, θ∈[0,2π) which defines the rotational pose of the listener 316b in the three-dimensional environment 400, in the form of a roll 402 data point, a pitch 404 data point, and a yaw 406 data point. These elements define a unique spatial relationship between the sound emitter, which is the sound source 316a and the receiver, which is the listener 316b.

This spatial configuration 316 is provided as input to the DANF module 310 which differs from a conventional neural network in both structure and functional objective. Unlike standard neural networks that process fixed-dimensional input and produce discrete output values, a neural field represents a continuous function over a spatial domain. That is, the NAF models the acoustic response—such as the room impulse response (RIR) as a continuous function of spatial coordinates and orientation, enabling predictions of the RIR at arbitrary source-listener configurations, not limited to those seen during training, or a fixed spatial grid.

The key advantage of this formulation is that the NAF learns to interpolate and generalize the acoustic response across the spatial domain of the environment. Once trained on a finite set of RIR measurements, the NAF can generate physically plausible RIRs for new, unseen locations and orientations with high spatial fidelity. This property enables efficient, scalable, and real-time spatial audio rendering, as well as robust support for dynamic scenarios such as head tracking in virtual or augmented reality environments.

In some embodiments the audio processing module 314 is configured to iteratively produce the spatial configuration 316 during the performance of the audio task 304. For example, during the performance of the audio task 304, if the listener 316b moves within the three-dimensional environment 400, their position and orientations changes. As a result, new coordinates corresponding to the listener's 316b position and orientation are captured by the audio system 302. These new coordinates are used to update the spatial configuration 316 as per the new position and orientation information of the listener 316b. Thereafter the DANF module 310 and the audio processing module 314 execute again with the new position and orientation information to again perform the audio task 304. This process is repeated iteratively till the continuation of the performance of the audio task 304.

In some embodiments, the neural field of the DANF module 310 may be further conditioned on additional environmental context, such as the geometry of a room or a set of bounce points, of the three-dimensional environment 400, to better capture reflections and spatial reverberation characteristics.

Accordingly, FIG. 5A is a schematic diagram showing an architecture 500a of the DANF module 310, according to an embodiment of the present disclosure. FIG. 5A is explained in conjunction with elements from FIG. 3A, FIG. 3B, and FIG. 3C.

The DANF module 310 includes a spatiotemporal feature extraction component 504 and an orientation-conditioned decoder 508 that generates multi-channel Ambisonic-format RIRs, such as the Ambisonic-format RIR 312.

A neural acoustic field is useful for spatial audio modeling because of its continuous, data-efficient, and geometry-aware capabilities over traditional discrete models. The neural acoustic fields establish the problem of estimating an RIR h∈ [symbol] ^{N×T}, where N is the number of microphone channels and T is the length of the RIR in samples. Some embodiments are based on recognition that it is possible to consider only the monaural or binaural cases or consider different listener orientations θ∈[0,2π) using post processing and/or other techniques. However, the training methods and evaluations of those NF do not consider inter-channel directional features that would correspond to changes in orientation for a fixed source/listener. A neural field can then be used to estimate the binaural RIR h∈ [symbol] ^{2×T} as a function of the listener position l∈ [symbol] ³, the source position s∈ [symbol] ³, and some fixed environmental context C:

$$h = N F ( s , l , θ , C ) .$$

In many neural acoustic fields, C is implicit, as a separate NF is trained for each environment. This environmental context can also be specified via a set of “bounce points”, e.g., each environment's geometry can be characterized by capturing a set of uniformly sampled points along the surface of each room's mesh, defining the environmental context as C=[c₁, . . . , c_{K}]∈ [symbol] ^{3×K}, with each bounce point cₖ being normalized such that the origin is at the midpoint of the minimum/maximum coordinates as defined by the dataset metadata.

On the other hand, in some embodiments, the DANF module 310 is trained to go beyond binaural RIR modeling, and model the Ambisonic-format RIR 312 as h∈ [symbol] ^{4×T} using a direction-aware neural field (DANF) framework:

$$h = DANF ( s , l , θ , C ) ,$$

where DANF is optimized based on reconstruction losses including a direction-aware component, as described below.

The architecture 500a of the DANF module 310 comprises two primary subsystems: the spatiotemporal feature extraction component 504 and the orientation-conditioned decoder 508, which together are configured to generate the multi-channel Ambisonic-format RIR 312 based on the spatial configuration 316 input.

In the illustrated embodiment, the spatiotemporal feature extraction component 504 receives as input 502, a set of features including: the spatial configuration 316 defined by the position s of the acoustic source 316a, the position l of the listener 316b, and the orientation θ of the listener 316b in a three-dimensional environment (such as the environment 400), and an environmental context C, which may include a geometric context of the three-dimensional environment 400, which may include description of a room, such as a set of bounce points sampled from reflective surfaces in the room; and a time index or time encoding corresponding to the desired sampling interval for the RIR output.

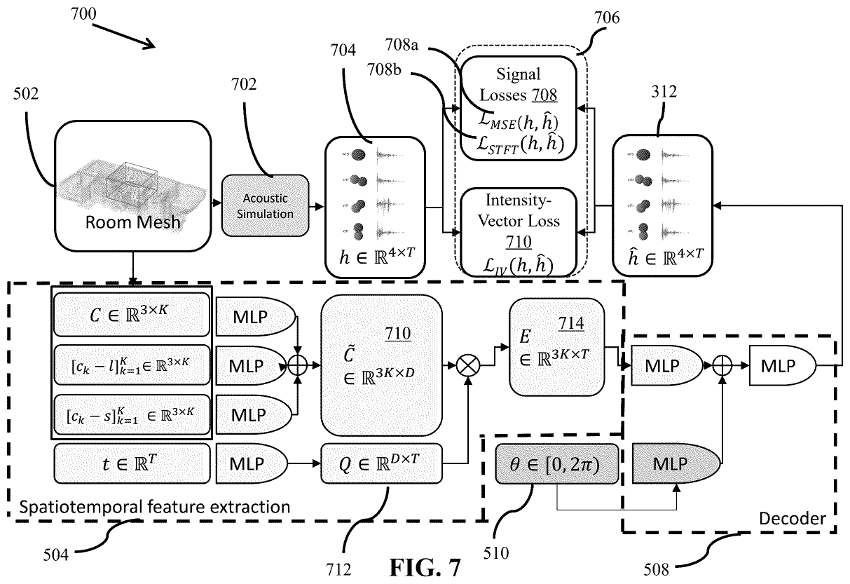

The input 502 is first encoded, by the spatio-temporal feature extraction component 504, using sinusoidal or positional encodings and passed through a set of neural network layers, such as multi-layer perceptrons (MLPs), to extract high-dimensional feature embeddings. In some embodiments, the spatial embedding may be composed of three sub-embeddings: one derived from the bounce points, one from the relative position vectors from bounce points to listener, and one from bounce points to source. These embeddings are concatenated and processed to form a unified spatiotemporal representation of the scene, in an embodiment. This will be described in detail in FIG. 7. As a result, spatio-temporal features 506 are received at the output of the spatio-temporal feature extraction component 504.

These spatio-temporal features 506 are then forwarded to the orientation-conditioned decoder 508, which is conditioned on an orientation of the listener 510. The orientation of the listener 510 is same as the orientation θ described earlier. The orientation-conditioned decoder 508 may include additional MLP layers or neural field operators that use the spatiotemporal features 506 and the listener orientation 510 encoding to predict the time-domain response of each Ambisonic channel. In some embodiments, the orientation-conditioned decoder 508 outputs the FOA Ambisonic-format RIR 312 comprising the four channels [W(t), X(t), Y(t), Z(t)], corresponding to the zeroth- and first-order spherical harmonic components of the sound field, as described earlier.

The architecture 500a shown in FIG. 5A enables the DANF module 310 to capture both the local directional characteristics of sound propagation and the temporal structure of acoustic responses. Unlike conventional neural networks that operate on discrete inputs and outputs, the DANF module 310 is implemented as a continuous neural field, capable of interpolating the acoustic response across arbitrary spatial and temporal coordinates within a room. This allows the audio system 302 to generalize to novel source-listener configurations with high spatial fidelity and to generate directionally resolved RIRs in a flexible and data-efficient manner.

In some embodiments, the DANF module 310 may be trained using a composite loss function comprising one or more of: a time-domain reconstruction loss (e.g., mean squared error), a time-frequency loss (e.g., STFT-based loss), and a direction-aware loss based on intensity vectors computed from the Ambisonic channels of the Ambisonic-format RIR 312. Thus, the architecture 500a of the DANF module 310 supports high-quality, orientation-aware audio rendering for applications in virtual reality, simulation, spatial audio synthesis, and machine learning data generation.

Accordingly, FIG. 5A illustrates a modular and extensible neural field architecture for generating Ambisonic-format RIRs with inherent spatial awareness and directional consistency.

FIG. 5B is a block diagram 500b illustrating an end-to-end pipeline of operations performed by the audio system, from spatial configuration input through Ambisonic rendering to downstream audio task execution, according to an embodiment of the present disclosure. FIG. 5B is explained in conjunction with elements from FIG. 3A, FIG. 3B, FIG. 3C, FIG. 4, and FIG. 5A.

The block diagram 500b illustrates a high-level system diagram illustrating the overall operation of the audio system 302 that leverages the functionality of the DANF module 310 to perform spatial audio processing, according to some embodiments of the present disclosure. The block diagram 500b illustrates the end-to-end data flow from spatial input through to spatialized audio output, integrating multiple modules including neural field inference, Ambisonic rendering, and downstream audio synthesis in an embodiment.

As shown in FIG. 5B, at 512, the audio system 302 receives the input 502, which includes the spatial configuration 316 comprising: the sound source position, s, representing the 3D coordinates of the sound emitter or the acoustic source 316a; the listener position l, indicating the 3D coordinates of the listener 316b; a listener orientation 516, which may be defined by a rotation vector θ and having yaw, pitch, roll components (such as those defined in FIG. 4); an optional room context, 502a, C=[c₁, . . . , c_{K}]∈ [symbol] ^{3×K} which may include bounce points or geometric descriptors of the acoustic environment.

These inputs 512 are processed at 514 by the spatiotemporal feature extraction module 504, which encodes the input 512 into a latent representation suitable for neural field inference. The encoded features are passed, at 518, to the orientation conditioned decoder 508, which is conditioned on the listener orientation 516 and outputs, at 522, a directionally resolved Ambisonic-format RIR 312. The Ambisonic-format RIR 312 is typically formatted as a first-order Ambisonic (FOA) signal capturing both omnidirectional and directional sound energy at the listener location.

Separately, at 520, the audio system 302 receives a dry (anechoic) audio signal, which represents the clean, source audio prior to environmental convolution. The Ambisonic-format RIR 312 produced by the DANF module 310 is convolved with the anechoic signal to produce, at 524, a spatialized Ambisonic audio signal, simulating how the source would sound at the specific source and listener position within the specified environment.

The spatialized signal may be forwarded to one or more downstream modules, depending on the task. In some embodiments, the spatialized signal is decoded into a binaural signal using head-related transfer functions (HRTFs) and rendered via headphones. In other cases, the spatialized signal is used for localization, enhancement, or simulation. This pipeline allows the audio system 302 to dynamically respond to changes in listener pose or environment, enabling real-time spatialization and adaptive spatial audio rendering. The modular design illustrated in FIG. 5A and FIG. 5B reflects the extensibility of the DANF-based audio system 302 and its ability to interface with conventional audio processing pipelines while providing direction-aware acoustic modeling.

Accordingly, FIG. 5B illustrates the overall signal flow and system components for performing spatial audio tasks using a direction-aware neural acoustic field, emphasizing how the learned RIR interacts with scene geometry and audio sources to produce perceptually accurate and spatially coherent sound fields.

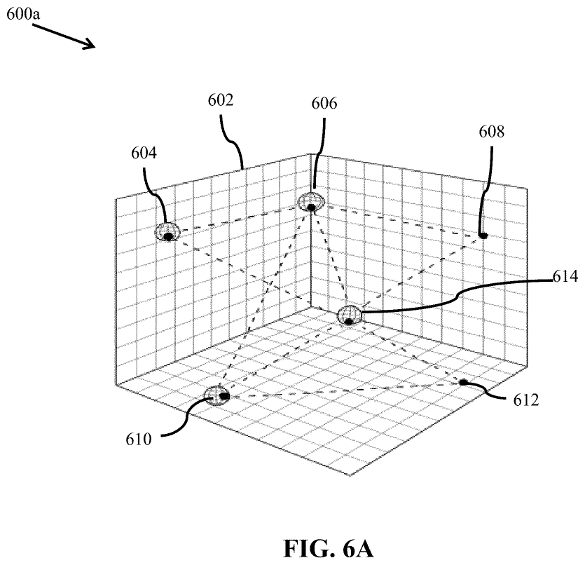

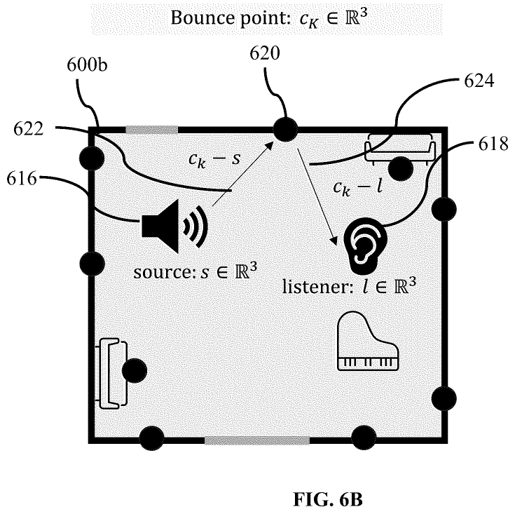

FIG. 6A is a schematic diagram showing an example of an acoustic environment 600a, according to an embodiment of the present disclosure. FIG. 6A is explained in conjunction with elements of FIG. 3A, FIG. 3B, FIG. 3C, FIG. 4, FIG. 5A, and FIG. 5B. The acoustic environment 600a may be equivalent to the three-dimensional environment 400 disclosed in FIG. 4.

In some embodiments, the acoustic environment 600a corresponds to a room. The acoustic environment 600a has reflective boundaries such as walls, ceiling, and floor. From these reflective boundaries, a collection of discrete spatial samples—referred to as bounce points—is extracted. Each bounce point corresponds to a position on a reflective surface where sound is likely to reflect before reaching a listener, such as the listener 316b. These bounce points may be determined through uniform sampling of a room mesh, simplified ray tracing, or other geometry-based heuristics, and are intended to approximate early reflections and significant surface interactions within the acoustic environment 600a. The bounce points provide information corresponding to the room context 502a, also referred to as the environmental context as C=[c₁, . . . , c_{K}]∈ [symbol] ^{3×K}, with each bounce point cₖ being normalized such that the origin is at the midpoint of the minimum/maximum coordinates as defined by the dataset metadata.

In an embodiment, to obtain data about bounce points, a room model is used. For example, FIG. 6A illustrates a mesh model 602 for the acoustic environment 600a, from which information about bounce points is obtained. The mesh model 602 may be used to capture the spatial configuration of the acoustic environment 600a and may further include metadata associated with surface properties, such as material characteristics, reflectivity, or acoustic absorption coefficients. In certain embodiments, the mesh model 602 is composed of triangular or quadrilateral faces, although other polygonal structures may be used.

In an embodiment, the mesh model 602 is used to obtain “bounce points” along the room boundary where sound reflects, which contribute to the RIR. For example, FIG. 6A illustrates six bounce points corresponding to the mesh model 602—a bounce point 604, a bounce point 606, a bounce point 608, a bounce point 610, a bounce point 612, and a bounce point 614. It may be understood that the number of bounce points is shown as six only for the sake of example. In practice, any equivalent number of bounce points may be sampled from the mesh model 602, without deviating from the scope of the present disclosure.

FIG. 6B is a schematic diagram further illustrating role of bounce points as geometric context of an acoustic environment 600b, according to an embodiment of the present disclosure. FIG. 6B is explained in conjunction with elements of FIG. 3A, FIG. 3B, FIG. 3C, FIG. 4, FIG. 5A, FIG. 5B and FIG. 6A. FIG. 6B illustrates as an example, the acoustic environment 602 including a source 616 and a listener 618. The source 616 may be equivalent to the source 316a and the listener 618 may be equivalent to the listener 316b. The acoustic environment 600b may be equivalent to the three-dimensional environment 400 disclosed in FIG. 4 and the acoustic environment 600a illustrated in FIG. 6A. The acoustic environment 600b includes one or more bounce points, such as a bounce point 620. The bounce points are used by the DANF module 310 as geometric context input corresponding to the acoustic environment 600b and are utilized to enhance the spatial conditioning of the DANF module 310. In the embodiment shown in FIG. 6B, the bounce point 620, a set of geometric relationships, is computed based on the relative positions of the sound source 616 and the listener 618. These relationships may include, for example, a vector 624 from the bounce point 620 to the listener 618, a vector 622 from the bounce point 620 to the source 616, and other derived spatial features. Each of these relationships provide bounce point descriptors, which are then encoded using either fixed or learned representations and passed into the spatiotemporal feature extraction component 504 of the DANF module 310.

In some embodiments, the DANF module 310 includes a spatial embedding module and an impulse response generation module. Using the principles of acoustic radiance transfer, the spatial embedding module learns features derived from the bounce points c₁, . . . , c_{K}∈ [symbol] ³, such the bounce point 620, as well as the relative location vectors from the bounce points to the listener

$${[ {c}_{k} - l ]}_{k = 1}^{K} ∈ {ℝ}^{3 \times K}$$

624 and from the bounce points to the source

$${[ {c}_{k} - s ]}_{k = 1}^{K} ∈ {ℝ}^{3 \times K} 622.$$

In an embodiment, this extraction of relationships and descriptors is done for all the bounce points in the acoustic environment 600b. The inclusion of bounce points allows the neural acoustic field of the DANF module 310 to be conditioned on the geometry of the acoustic environment 600b without relying on computationally expensive acoustic simulation during inference. This representation enables the audio system 302 to internalize spatial structure in a flexible and learnable way, improving its ability to generate room impulse responses that reflect the directional and reverberant characteristics of the environment. Furthermore, because bounce points serve as a compact and expressive encoding of room geometry, they allow the DANF module 310 to generalize effectively to new or unseen environments, including scenarios with limited measurement data. This property is especially valuable in few-shot learning applications, where only a small number of room impulse responses are available for a given space.

By incorporating bounce point information into the neural field of the DANF module 310, the audio system 302 improves its capacity to model early reflections and directional propagation effects, thereby enabling more realistic and directionally consistent Ambisonic output. Accordingly, FIG. 6A and FIG. 6B demonstrate how the use of bounce points bridges the gap between explicit room geometry and data-driven neural acoustic modeling, providing a foundation for efficient and accurate spatial audio synthesis.

Additionally, the use of bounce points enables the audio system 302 to incorporate geometric priors without requiring full ray tracing or wave simulation. This geometric context provides a compact yet expressive summary of the room layout, allowing the DANF module 310 to produce more accurate and spatially consistent RIRs, particularly in environments with complex reflectivity patterns or limited measurement coverage. By conditioning the neural acoustic field on bounce point features, the DANF module 310 gains an improved understanding of directional propagation paths, reverberant structures, and occlusion effects. This improves generalization of the audio system 302 to novel source-listener configurations and supports geometry-aware learning with only a small number of RIR measurements, enabling few-shot or zero-shot adaptation to new rooms.

FIG. 7 illustrates a schematic diagram 700 showing an example implementation of various modules of the audio system 302 producing Ambisonic-format RIR 312, according to an embodiment of the present disclosure. FIG. 7 is explained in conjunction with elements from FIG. 3A, FIG. 3B, FIG. 3C, FIG. 4, FIG. 5A, FIG. 5B, FIG. 6A, and FIG. 6B.

In some embodiments, the schematic diagram 700 shows details of the architecture 500a of the DANF module 310 disclosed earlier in FIG. 5A.

In an embodiment, the DANF module 310 includes the spatiotemporal feature extraction component 504 which receives as the input 502 the set of features including: the spatial configuration 316 defined by the position s of the acoustic source 316a, the position l of the listener 316b), the environmental context C, which may include the geometric context of the three-dimensional environment 400, which may include description of a room, such as a set of bounce points sampled from reflective surfaces in the room, and the time index or time encoding corresponding to the desired sampling interval for the RIR output. These features are derived from a model of the room mesh, such as the mesh model 602 shown in FIG. 6A. In some embodiments, the information from the set of bounce points is received in the form of the relative location vectors from the bounce points to the listener

$${[ {c}_{k} - l ]}_{k = 1}^{K} ∈ {ℝ}^{3 \times K}$$

and from the bounce points to the source

$${[ {c}_{k} - s ]}_{k = 1}^{K} ∈ {ℝ}^{3 \times K} ,$$

such as those discussed in FIG. 6B.

The input 502 is first encoded by the spatio-temporal feature extraction component 504, using sinusoidal or positional encodings and passed through a set of neural network layers, such as multi-layer perceptrons (MLPs), to extract a high-dimensional spatial feature embedding 710, \tilde{C}∈ [symbol] ^{3K×D} (a 2-layer MLP for the bounce points matrix C∈ [symbol] ^{3×K} and a single layer MLP for the relative location vectors). In some embodiments, the spatial feature embedding 710 may be composed of three sub-embeddings: one derived from the bounce points, C∈ [symbol] ^{3×K}; one from the relative position vectors from bounce points to listener,

$${[ {c}_{k} - l ]}_{k = 1}^{K} ∈ {ℝ}^{3 \times K} ;$$

and one from bounce points to source

$${[ {c}_{k} - s ]}_{k = 1}^{K} ∈ {ℝ}^{3 \times K} .$$

These embeddings are concatenated and processed to form a unified spatiotemporal representation of the acoustic environment, in an embodiment.

Further, we then choose a set of time samples

$${\{ {t}_{i} \}}_{i = 1}^{T}$$

are encoded via sinusoidal encoding and an MLP to create a set of time-domain basis functions 712 Q∈ [symbol] ^{D×T}, which is multiplied with the concatenated spatial feature embedding 710 to produce a spatial-temporal feature 714 E∈ [symbol] ^{3K×T}.

In an embodiment, this spatial-temporal feature 714 is produced at the output of the spatio-temporal feature extraction component 504 and is further concatenated with a learned encoding (represented by the MLP in FIG. 7) of the listener orientation 510, θ∈[0,2π), at the impulse response generation module, which predicts an N-channel impulse response via an MLP network.

This spatial temporal feature 714 vector forms the input to a second-stage MLP referred to as the orientation conditioned decoder 508, which is conditioned on the listener orientation 510 and trained to produce the multi-channel Ambisonic-format RIR 312:

$$\hat{h} ( t ) = [ \hat{W} ( t ) , \hat{X} ( t ) , \hat{Y} ( t ) , \hat{Z} ( t ) ] .$$

This output is a first-order Ambisonic (FOA) representation, with one omnidirectional and three directional channels that together encode the time-domain spatial impulse response at the listener's position and orientation.

In an embodiment, the DANF module 310 is trained to minimize a composite loss function 706 that enforces both waveform accuracy and directional fidelity. The composite loss function 706 comprising signal losses 708, which further comprises a first component of a time-domain loss 708a, [symbol] _{MSE}, such as mean squared error (MSE), comparing the predicted and ground-truth Ambisonic waveforms. The signal losses 708 also include a second component which is a time-frequency loss 708b, [symbol] _{STFT}, computed using the short-time Fourier transform (STFT), which aligns the spectral characteristics of the predicted and target RIRs. The composite loss function 706 further includes an intensity vector loss 710, [symbol] _{IV}, to account for an inter-channel loss. The intensity vector loss 710 quantifies the alignment of directional energy flow in the time-frequency domain and encourages the DANF module 310 to preserve spatial consistency across orientations and environments.

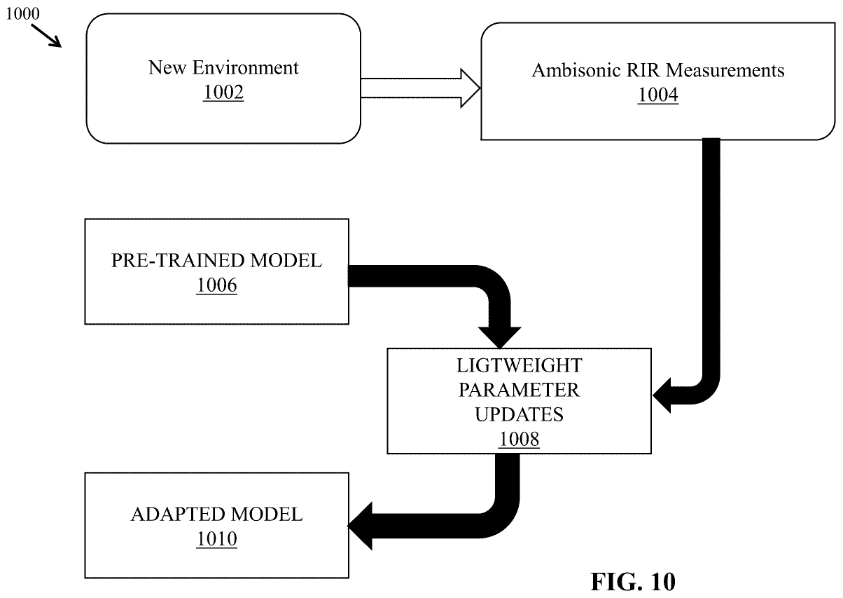

The outputs of the three loss terms—the time-domain loss 708a, [symbol] _{MSE}; the time-frequency loss 708b, [symbol] _{STFT}; and the intensity vector loss 710, [symbol] _{IV}, are combined into a total loss function or the composite loss function 706 used to train the parameters of the DANF module 310 through backpropagation. In some embodiments, the training procedure of the DANF module 310 supports optimization with low-rank parameter adaptation (e.g., LoRA) to enable efficient fine-tuning for new environments with limited data. This will be further explained in conjunction with FIG. 10.

In the embodiment illustrated in FIG. 7, the Ambisonic format RIR 312 is the predicted Ambisonic RIR of the DANF module 310, which is compared to ground-truth data using the composite loss function 706 that includes three terms. The first is the time-domain loss 708a between predicted and ground-truth waveforms. The time-domain loss 708a is used to assess the accuracy of an estimated signal ĥ via direct mean squared error (MSE) loss:

$${ℒ}_{MSE} ( \hat{h} , h ) = {‖ \hat{h} - h ‖}_{2}^{2} .$$

The time-frequency loss 708b is used to approximate human perception and utilize a time-frequency representation of the signal, such as the STFT H. The magnitude STFT|H| and STFT phase ΓH are also often considered.

In some embodiments, a combination of time domain and time-frequency domain signal reconstruction losses, such as the STFT loss, which is a combination of the magnitude loss, [symbol] _{mag}=∥|Ĥ|−|H|∥₁, phase loss [symbol] ₚₕₐₛₑ=∥ΓĤ−ΓH∥₂, and spectral convergence

$${ℒ}_{sc} = \frac{{‖ \vert \hat{H} \vert - \vert H \vert ‖}_{2}}{{‖ \vert H \vert ‖}_{2}}$$

is used to estimate the time-frequency loss 708b:

[symbol]

_{STFT}= [symbol] _{mag}+ [symbol] ₚₕₐₛₑ+ [symbol] _{sc}

To account for interchannel information that indicates directivity, the intensity vector loss 710 of the original and reconstructed RIRs is used. In an embodiment, the intensity vector IV(U) (m, f) is integrated along the frequency axis and the time axis, leading to a vector \vec{I}(h)∈ [symbol] ³. This averaged vector corresponds to the DoA of a signal propagating from a single source to a listener in an anechoic setting which should be captured in the early components of the RIR.

For the multi-channel Ambisonic-format RIR 312:

$$\hat{h} ( t ) = [ \hat{W} ( t ) , \hat{X} ( t ) , \hat{Y} ( t ) , \hat{Z} ( t ) ]$$

each component is treated as a separate channel in a 4-channel first-order Ambisonics (FOA) signal u(t)=[w(t), x(t), y(t), z(t)]^{T}, where t=1, . . . , T is the time sample index, and T is the number of time samples. To gain insight on the DoA of sources in a scene, which tends to be associated with the azimuth and elevation of maximum intensity of the recorded signal u∈ [symbol] ^{4×T}, the intensity vector is computed from the complex time-frequency representation of each of the FOA components, for example obtained using the short-time Fourier transform (STFT) U∈ [symbol] ^{4×M×F}, where M and F denote the number of time frames and frequency bins, respectively, and N=4 is the number of channels:

$$IV ( U ) ( m , f ) = [ \begin{matrix}Re ( {W ( m , f )}^{*} X ( m , f ) ) \\ Re ( {W ( m , f )}^{*} Y ( m , f ) ) \\ Re ( {W ( m , f )}^{*} Z ( m , f ) )\end{matrix} ] ,$$

where m denotes the time frame index, f the frequency bin index, * the complex conjugate, and Re the real component of a complex number.

In some embodiments, the directional consistency of the output produced by the DANF module 310 is further enforced during training using a loss function based on the acoustic intensity vector, computed from the FOA channels in the time-frequency domain as:

$$I ( m , f ) = \text{?} \{ {W}^{*} ( m , f ) \cdot [ X ( m , f ) , Y ( m , f ) , Z ( m , f ) ] \} ,$$

where f is the frequency bin index, R denotes the real part, and W*(t, f) is the complex conjugate of the STFT of the W channel. This formulation provides a physics-based interpretation of the DoA and supports robust training by guiding the DANF module 310 to align predicted and ground-truth spatial energy distributions.

In some embodiments, the intensity vector loss 710 is derived by applying the STFT to the predicted FOA channels and computing the real part of the product between the conjugate of the omnidirectional channel Ŵ*(m, f) and each directional channel \hat{X}(m, f), Ŷ(m, f), \hat{Z}(m, f), yielding a vector field:

$$\hat{I} ( m , f ) = \text{?} \{ {\hat{W}}^{*} ( m , f ) \cdot [ \hat{X} ( m , f ) , \hat{Y} ( m , f ) , \hat{Z} ( m , f ) ] \} .$$

A similar operation is performed on the ground-truth FOA RIR, and the cosine similarity between the estimated and true intensity vectors is used as the direction-aware loss term. This loss encourages the DANF module 310 to produce not just waveform-matching outputs, but ones that maintain coherent spatial energy flow consistent with the physical DoA of sound.

In some embodiments, the intensity vector loss 710, [symbol] _{IV}, based on the cosine distance between these averaged intensity vectors for the reference and estimated RIRs is given as:

$${ℒ}_{IV} ( \hat{h} , h ) = \frac{1}{2} ( 1 - \frac{〈 \vec{I} ( \hat{h} ) ; \vec{I} ( h ) 〉}{‖ \vec{I} ( \hat{h} ) ‖ ‖ \vec{I} ( h ) ‖} )$$

Accordingly, FIG. 7 illustrates the modular structure and training workflow of the DANF module 310, showing how spatial geometry, directional supervision, and multi-scale losses are integrated to produce high-fidelity Ambisonic RIRs suitable for downstream spatial audio applications.

Accordingly, FIG. 7 illustrates the complete model architecture and training pipeline of the acoustic system 302 including the DANF module 310, showing how input spatial and geometric parameters are transformed into high-dimensional acoustic predictions, and how a combination of temporal, spectral, and directional supervision enables accurate and consistent modeling of Ambisonic RIRs for spatial audio rendering.

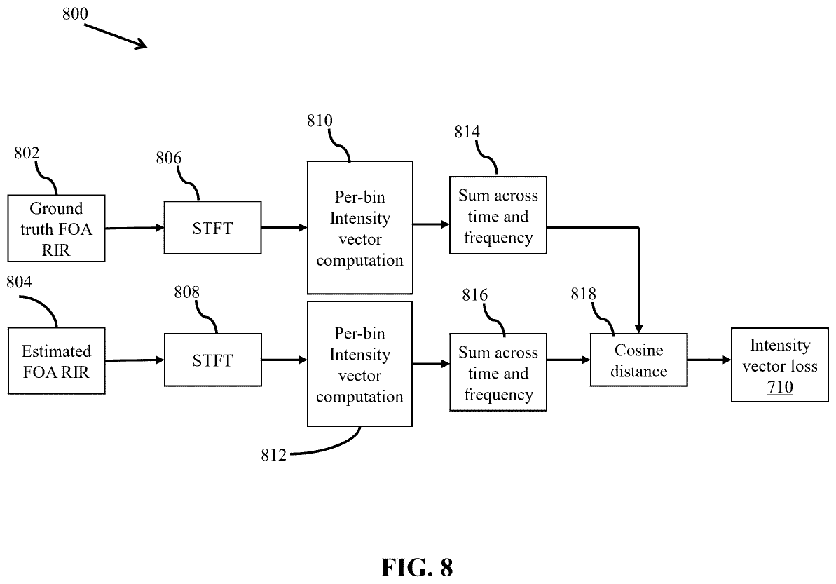

FIG. 8 is a flowchart illustrating a pipeline 800 of the intensity vector loss 710 calculation, according to an embodiment of the present disclosure. FIG. 8 is explained in conjunction with elements from FIG. 7.

As discussed in FIG. 7, the intensity vector loss 710 [symbol] _{IV}, is used during training of the DANF module 310 to enforce accurate modeling of directional acoustic energy. The pipeline 800 illustrates how, for an estimated first-order Ambisonic RIR \hat{r}(t) 804, a short-time Fourier transform (STFT) 808 is applied 812 to each of the four Ambisonic channels: omnidirectional Ŵ(t) and directional \hat{X}(t), Ŷ(t), \hat{Z}(t). The resulting complex-valued time-frequency representations 816 Ŵ(m, f), \hat{X}(m, f), Ŷ(m, f), Ź(m, f) are then used to compute a predicted acoustic intensity vector as:

$$\hat{I} ( m , f ) = \text{?} \{ {\hat{W}}^{*} ( m , f ) \cdot [ \hat{X} ( m , f ) , \hat{Y} ( m , f ) , \hat{Z} ( m , f ) ] \} ,$$

where [symbol] {⋅} denotes the real part and Ŵ*(m, f) is the complex conjugate of the omnidirectional channel. A corresponding ground-truth intensity vector Iₜᵣᵤₑ(m, f) is computed 802 from the reference FOA RIR, and STFT 806 is applied 810 per-bin or per channel to obtain the ground truth intensity vector as a resulting vector 814 after summing across time and frequency. To compare the resulting estimated 816 and true 814 intensity vectors, a cosine similarity or cosine distance 818 is used after summing the intensity vectors across time and frequency:

$${ℒ}_{intensity} = 1 - cos ( \hat{I} , {I}_{true} ) ,$$

This intensity vector loss 710 complements conventional time-domain and frequency-domain losses by directly supervising the spatial orientation of the modeled sound field, ensuring that the predicted Ambisonic-format RIR 312 not only reproduces the acoustic waveform but also aligns with the directional energy distribution of the true sound field in the input 502. The intensity vector loss 710, along with the time-domain loss 708a and the frequency-domain loss 708b is used for training the DANF module 310.

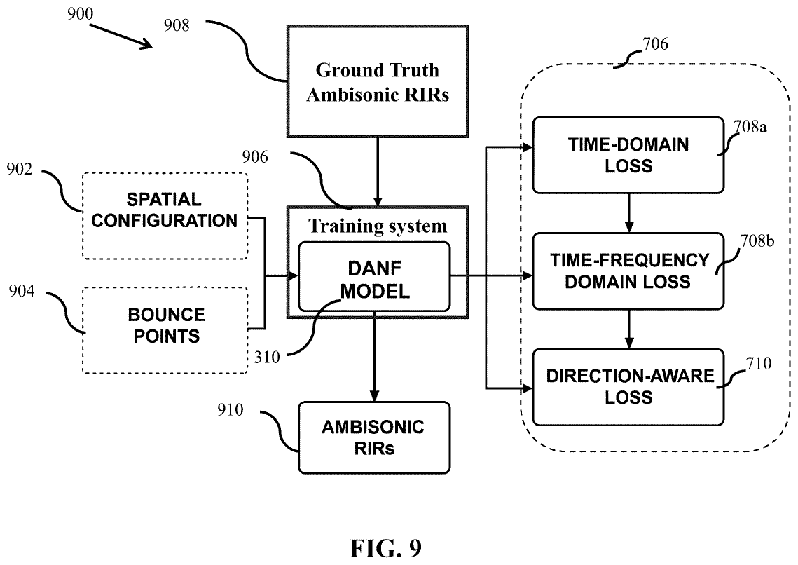

FIG. 9 illustrates a schematic diagram showing training process 900 of the DANF module 310, according to an embodiment of the present disclosure. FIG. 9 is explained in conjunction with elements from FIG. 3A, FIG. 3B, FIG. 3C, FIG. 4, FIG. 5A, FIG. 5B, FIG. 7, and FIG. 8.

The training process 900 is used as an end-to-end learning process by which the DANF module 310 is configured to generate directionally consistent and acoustically accurate Ambisonic-format room impulse responses (RIRs) based on a combination of spatial and geometric inputs.

The training process 900 begins with the ingestion of a spatial configuration 902 into a training system 906 for the DANF module 310, which specifies the position of the sound source, the position of the listener, and the orientation of the listener within a three-dimensional environment (such as the three-dimensional environment 400 shown in FIG. 4). This configuration serves as a parameterization of the acoustic interaction space and is fundamental to the directional modeling of the RIR. The spatial configuration 902 is equivalent to the spatial configuration 316 shown in FIG. 3A.

In addition to the spatial configuration 902, the training system 906 also receives a set of bounce points 904, which represent sampled positions on reflective surfaces in the three-dimensional environment. These bounce points provide geometric context and enable the model to infer room-dependent acoustic phenomena such as early reflections and directional reverberation patterns. The set of bounce points 904 are equivalent to the set of bounce points associated with the environmental context or room context 502a as C=[c₁, . . . , c_{K}]∈ [symbol] ^{3×K} disclosed in FIG. 5A and FIG. 5B.

Both the spatial configuration 902 and the bounce points 904 are encoded through the spatiotemporal feature extraction component 504 of the DANF module 310, which processes the input through a series of neural network layers to produce a latent representation of the acoustic scene.

This latent representation is then passed to the orientation-conditioned decoder 508, which outputs a multi-channel Ambisonic-format RIR 910 (which is equivalent to the Ambisonic-format RIR 312). In one embodiment, the orientation-conditioned decoder 508 predicts a first-order Ambisonic response, comprising the channels [W(t), X(t), Y(t), Z(t)], which collectively represent omnidirectional and directional components of the sound field at the listener's location.

The predicted Ambisonic RIR 910 is compared to ground-truth data using a composite loss function that includes three terms. The composite loss function 706 was discussed in FIG. 7.

The composite loss function 706 has a first term corresponding to the is the time-domain loss 708a, the second term corresponding to the time-frequency domain loss 708b and the third term corresponding to the direction aware or the intensity vector loss 710. The outputs of these three loss terms are combined into the composite loss function 706 and are used to train the parameters of the DANF module 310 through backpropagation. In some embodiments, the training process 900 supports optimization with low-rank parameter adaptation (e.g., LoRA) to enable efficient fine-tuning for new environments with limited data.

FIG. 10 illustrates a flowchart of a method 1000 for a low-rank adaptation (LoRA) mechanism that enables few-shot adaptation of the DANF module 310 to new environments using lightweight parameter updates, according to an embodiment of the present disclosure.

The method 1000 includes collecting 1004 Ambisonic RIR measurements from a new environment 1002. The collected 1004 Ambisonic RIR measurements are used to adapt a pre-trained model 1006 to a novel room while updating only a lightweight set of parameters 1008. The pre-trained model 1006 may correspond to the DANF module 310 that was trained using the training process 900 illustrated in FIG. 9.

In some embodiments, the DANF module 310 is initially trained on a diverse set of base environments, allowing it to generalize to a broad range of spatial configurations. The pre-trained model 1006 includes a feature extraction module (such as the spatio-temporal feature extraction component 504) and a decoder (such as the orientation conditioned decoder 508) for predicting Ambisonic-format RIRs from spatial configuration and geometric input. In the context of adapting this model to a new environment—such as a previously unseen room with different reflective and reverberant properties—it is inefficient and often impractical to retrain the entire neural field using a full set of parameters and dense RIR measurements.

To address this challenge, the DANF module 310 utilizes Low-Rank Adaptation (LoRA), a technique that inserts trainable, low-rank matrices into specific layers of the neural network, typically the linear layers of the decoder. Instead of updating all network parameters, only the low-rank matrices A and B are trained during adaptation. These matrices satisfy the constraint that their product AB^{T} approximates a correction to the original weight matrix, but with significantly fewer parameters. This allows the model to adapt to the new environment with minimal computational overhead and memory footprint to obtained the adapted model 1010 corresponding to updated parameters of the DANF module 310.

In operation, the pre-trained weights are held fixed, and LoRA modules are optimized using a small number of measured RIRs—often fewer than 80, and as low as 1 in some scenarios. The bounce points representing the geometry of the new room of the new environment 1002 are provided as input alongside the spatial configuration, and the LoRA-augmented model is trained to minimize the same composite loss used in full training (e.g., time-domain, frequency-domain, and direction-aware losses).

In some embodiments, training the DANF module 310 using the LoRA methodology disclosed in the method 1000 allows the DANF module 310 to quickly and effectively generalize to new environments without retraining from scratch, making it well-suited for scalable deployment in real-world applications such as VR/AR audio rendering, spatial audio personalization, or acoustic simulation for robotics.

Accordingly, FIG. 10 illustrates the architectural design and adaptation process by which LoRA enables few-shot learning of room acoustics, ensuring that the neural field remains efficient, portable, and robust across a wide variety of listening environments.

To that end, the DANF module 310 is thus used in the audio system 302 to perform a wide variety of audio tasks 304, some of which are discussed in the following descriptions.

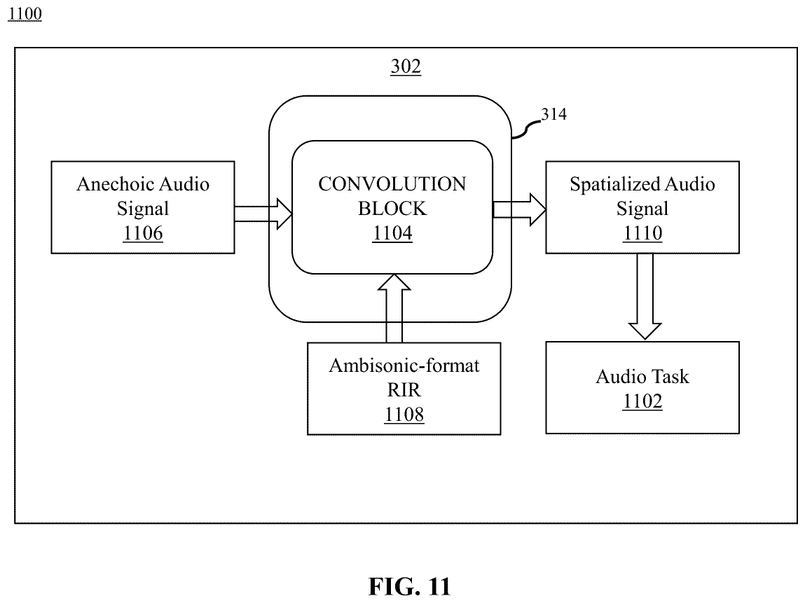

FIG. 11 illustrates a schematic of an audio processing pipeline 1100 configured to generate a spatialized Ambisonic audio signal 1110 and perform an audio task 1102 based on the spatialized Ambisonic audio signal 1110, according to some embodiments. FIG. 11 is explained in conjunction with elements from FIG. 3A.

As shown in the audio processing pipeline 1100, the audio system 302 includes the audio processing module 314 that receives two inputs: (1) an anechoic audio signal and 1106 (2) an Ambisonic-format room impulse response (RIR) 1108 (equivalent to the Ambisonic-format RIR 312). The anechoic audio signal 1106 represents a sound source without reverberation, while the Ambisonic-format RIR 1108 encodes spatial and reverberant characteristics of a virtual or real acoustic environment, including an omnidirectional channel and a plurality of directional channels.

The audio processing module 314 is configured to convolve the anechoic audio signal 1106 with the Ambisonic-format RIR 1108, in a convolution block 1104. The convolution block 1104 is configured to simulate spatial acoustic characteristics by applying a convolution operation between the anechoic audio signal 1106 and the Ambisonic-format RIR 1108. The convolution block performs a convolution operation including performing an integral of a discrete convolution over sampled time signals. The resulting output signal is the spatialized audio signal 1110 that encodes directional and temporal information from the Ambisonic-format RIR 1108, effectively embedding the source audio into a virtual acoustic environment that preserves spatial cues consistent with the Ambisonic format. This allows downstream processing or rendering modules to produce immersive, 3D audio experiences.

In an embodiment, this convolution operation simulates the propagation of the sound source within the defined spatial environment, resulting in a multi-channel audio representation that reflects spatial localization, reverberation, and other acoustic cues.

The resulting spatialized (Ambisonic) audio signal 1110 is then provided to one or more audio task modules, which are configured to perform the audio task 1102 including various audio-related operations. In some embodiments, the audio task 1102 may include, but is not limited to, sound source localization, spatial speech enhancement, acoustic scene simulation, or the generation of training data for machine learning models.

Accordingly, FIG. 11 illustrates that the audio system 302 leverages spatial audio modeling to enhance the realism and effectiveness of audio task execution, by using the Ambisonic-format RIR 1108 to introduce accurate spatial characteristics into the signal prior to task-specific processing.

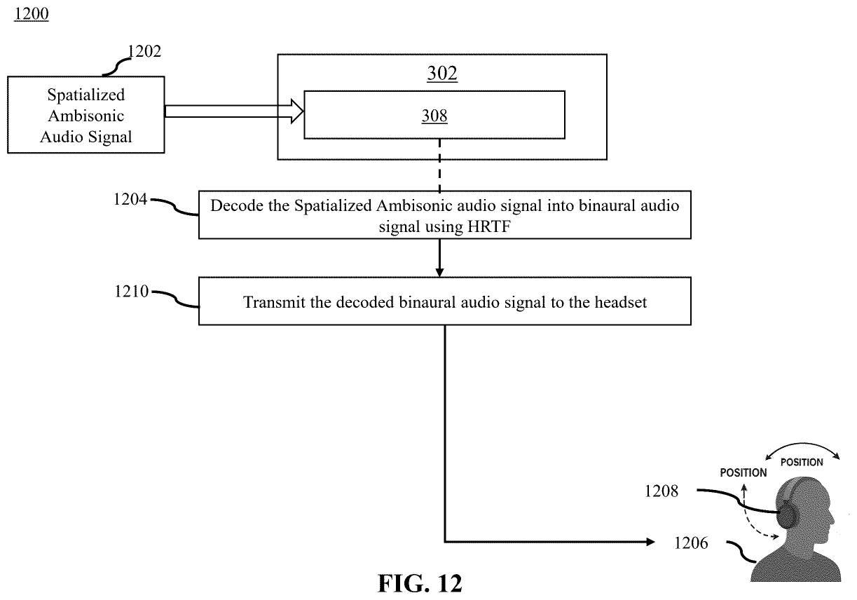

FIG. 12 illustrates a flowchart of a method 1200 for an audio task performed by the audio processing module 308 of the audio system 302 for rendering VR/AR audio scenes to a headset 1208 by decoding a spatialized Ambisonic signal into a binaural signal using an HRTF aligned with a listener's 1206 head orientation, according to an embodiment of the present disclosure. FIG. 12 is explained in conjunction with elements from all of the preceding figures.

The audio system 302 includes the audio processing module 308 that is configured at 1202, to receive a spatialized Ambisonic audio signal 1202 as input. The spatialized Ambisonic audio signal 1202 is generated by the DANF module 310 in an embodiment, as discussed in FIG. 11. The spatialized Ambisonic audio signal 1202 encodes the spatial characteristics of the audio scene, including directional information and room acoustics, enabling immersive three-dimensional sound rendering.

The audio processing module 308 is further configured to, at 1204, decode the spatialized Ambisonic audio signal into a binaural audio signal suitable for headphone 1208 playback. This decoding operation is performed using a head-related transfer function (HRTF), which simulates how sound waves interact with the listener's 1206 head, ears, and torso. In some embodiments, the HRTF is dynamically selected or interpolated based on the head orientation of the listener 1206, which may be tracked in real time via sensors embedded in the headset 1208.

Once the binaural audio signal is generated, the audio processing module 308 is configured, at 1210 to transmit the decoded binaural signal to the headset 1208 of the listener 1206, where it is rendered through the headphones of the headset 1208 for playback to the listener 1206. This process creates a highly realistic and immersive auditory experience, in which sound sources appear to originate from fixed positions in space, even as the listener's 1206 head moves.

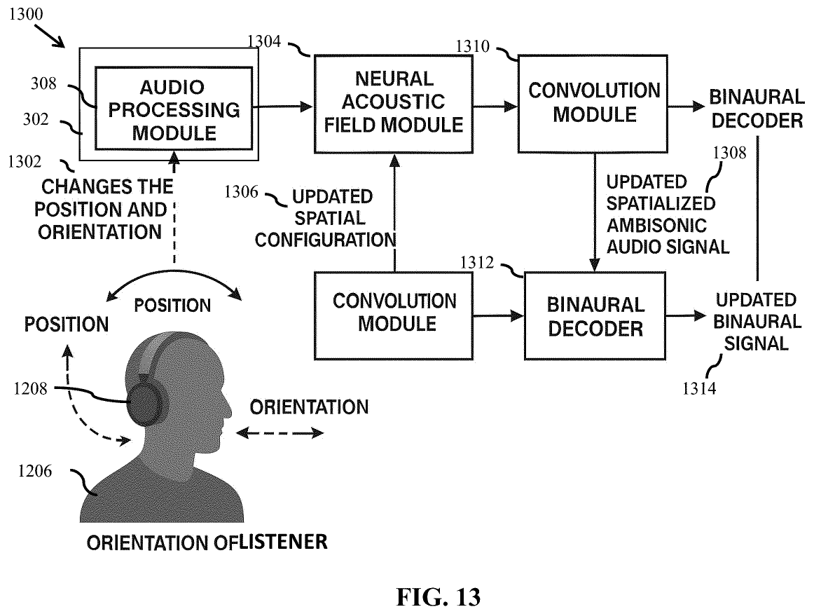

FIG. 13 illustrates a schematic diagram 1300 showing a dynamic update of a binaural audio signal in real time based on changes in the position and/or orientation of the listener, according to some embodiments of the present disclosure. FIG. 13 is explained in conjunction with elements from FIG. 12.

As depicted in the schematic diagram 1300, the audio system 302 includes the audio processing module 308 operatively coupled to a listener tracking subsystem including the listener 1206 and the headphone 1208, and a neural acoustic field module 1304. The neural acoustic field module 1304 is equivalent to the DANF module 310. The listener tracking subsystem is configured to detect changes 1302 in the listener's 1206 spatial configuration, including their position and head orientation within a virtual or physical environment.

Upon detecting the change 1302, the audio processing module 308 updates 1306 the spatial configuration and submits this updated spatial metadata to the neural acoustic field module 1304. The neural acoustic field module 1304 is configured to generate an updated Ambisonic-format room impulse response (RIR) 1308 corresponding to the new listener position and orientation.

Next, the audio processing module 308 performs a real-time convolution 1310 of the updated Ambisonic RIR with a stored or incoming anechoic audio signal, producing the updated spatialized Ambisonic audio signal 1308 that accurately reflects the revised listener context.

The audio system 302 then proceeds to decode 1312 the updated Ambisonic signal into an updated binaural signal 1314, using a head-related transfer function (HRTF) corresponding to the latest head orientation. This decoding ensures that the binaural signal reflects realistic spatial cues relative to the listener's current orientation.

Finally, the updated binaural signal 1314 is rendered to the headphones 1208 of the headset worn by the listener 1206, providing a perceptually continuous and immersive auditory experience as the listener 1206 moves or turns their head.

Accordingly, FIG. 13 illustrates a closed-loop spatial audio rendering pipeline in which listener movement directly influences real-time signal processing to maintain accurate and immersive sound localization within dynamic virtual or augmented environments.

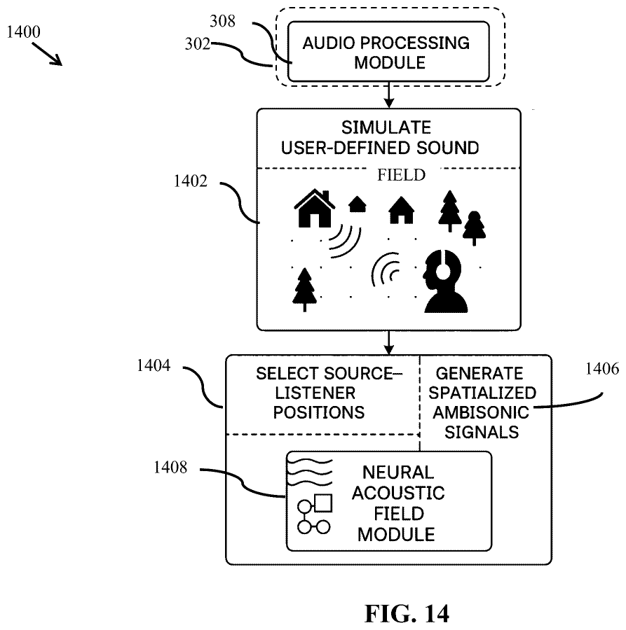

FIG. 14 illustrates a schematic diagram 1400 of the audio system 302 configured to simulate an acoustic scene within a virtual environment, according to some embodiments of the present disclosure. FIG. 14 is explained in conjunction with elements from FIG. 11.

The audio system 302 is configured to perform the audio task 1102 of acoustic scene simulation. To perform the audio task 1102, the audio processing module 308 of the audio system 302 is configured to simulate 1402 a user-defined sound field within a virtual environment by selecting 1404 source-listener positions and generating 1406 corresponding spatialized Ambisonic signals using a neural acoustic field module 1408. The neural acoustic field module 1408 is equivalent to the DANF module 310 of the audio processing module 308.

In some embodiments, the audio processing module 308 is configured to allow a user or system designer to define the virtual acoustic scene by the selection 1402 of the one or more source-listener position pairs within a modeled environment.

In some embodiments, the audio processing module 308 communicates the information to the neural acoustic field module 1408, which is configured to generate one or more Ambisonic-format room impulse responses (RIRs) corresponding to the selected source and listener locations. These one or more Ambisonic-format RIRs capture both directional and reverberant characteristics of the virtual environment, as modeled by the neural acoustic field 1408. The audio processing module 308 then uses the generated RIRs to simulate spatialized Ambisonic audio signals by convolving each RIR with a corresponding anechoic audio signal. This process creates a realistic representation of how each sound source would be perceived at the listener's location within the modeled environment, incorporating spatial cues and room dynamics.

The generated spatialized Ambisonic signals 1406 may be used for a variety of purposes, such as training data generation, perceptual testing, content creation, or immersive audio playback in virtual or augmented reality applications.

Accordingly, FIG. 14 illustrates that the audio system 308 enables flexible, user-defined acoustic scene simulation by leveraging a neural rendering engine to generate high-fidelity Ambisonic representations of virtual sound fields.

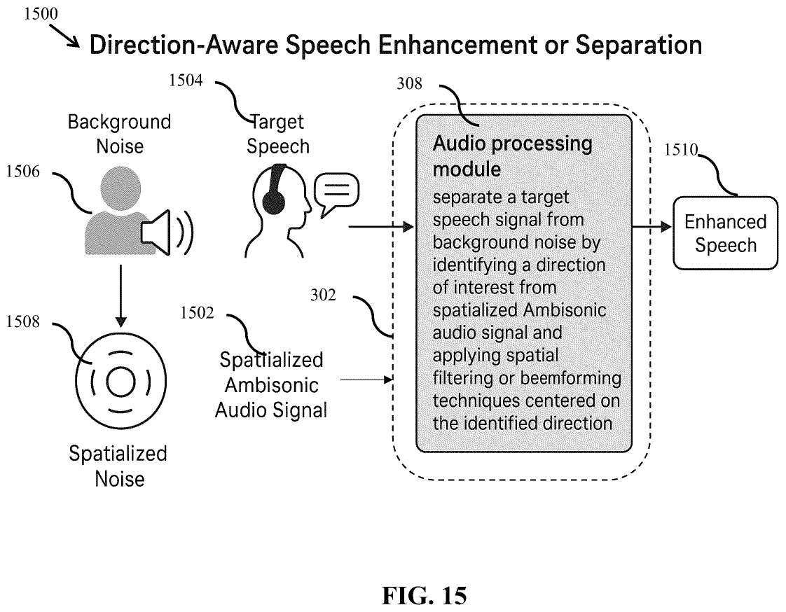

FIG. 15 illustrates a schematic diagram 1500 of the audio system 302 configured to perform the audio task comprising direction-aware speech enhancement or separation, according to some embodiments of the present disclosure. FIG. 15 is explained in conjunction with elements from FIG. 11.

As illustrated in the schematic diagram 1500, the audio system 302 includes the audio processing module 308 that receives as input a spatialized Ambisonic audio signal 1502, which captures a multi-directional representation of a sound field. The spatialized Ambisonic audio signal 1502 includes both a target speech source 1504 and one or more background noise sources 1506, each arriving from different spatial directions.

The audio processing module 308 is configured to analyze the directional content of the spatialized Ambisonic audio signal 1502 to identify a direction of interest, corresponding to the presumed location of the target speech source 1504. In some embodiments, this may involve calculating a direction-of-arrival (DoA) estimate using spatial features such as intensity vectors or beam energy distributions. Using the proposed direction aware neural acoustic field can improve the DOA estimation accuracy by quickly calculating RIRs at many possible target speech source locations and using the knowledge of the sound propagation and reverberation to more accurately estimate the DoA.

Once the direction of interest has been determined, the audio processing module 308 applies spatial filtering or beamforming techniques focused on that direction. These techniques enhance signal components arriving from the target direction while attenuating off-axis noise or interference, effectively separating the target speech signal from the background 1506, which may include spatialized noise 1508. These techniques can also be further aided by the RIRs estimated from the neural acoustic field of the DANF module 310 of the audio system 302.

The output of the audio processing module 308 may be a cleaned or enhanced speech signal 1510 containing primarily the speech of interest, which may be further processed for tasks such as speech recognition, transmission, or playback in a noise-robust manner.

Accordingly, FIG. 15 demonstrates how the audio system 302 leverages Ambisonic spatial information and directional signal processing to perform targeted speech enhancement or separation in complex acoustic environments, enabling improved performance in communication, interaction, or machine listening applications.

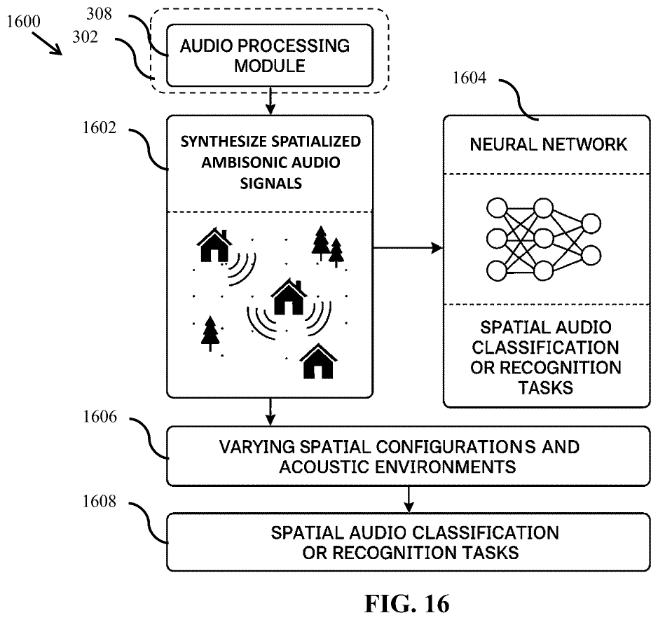

FIG. 16 illustrates a schematic diagram 1600 of the audio system 302 configured to perform an audio task comprising the generation of training data for machine learning models, according to some embodiments. FIG. 16 is explained in conjunction with elements from FIG. 11. The audio task is equivalent to the audio task 1102.

As shown in the schematic diagram 1600, the audio system 302 includes the audio processing module 308 coupled to a neural network module 1604. The audio processing module 308 is configured to synthesize spatialized Ambisonic audio signals 1602 by simulating 1606 sound fields under a range of spatial configurations and acoustic environments. These configurations may include varying sound source positions, listener orientations, room geometries, and environmental conditions such as reverberation or background noise levels.

To generate the spatialized signals, the audio processing module 308 selects a combination of source and listener positions and retrieves or generates corresponding Ambisonic-format RIRs (such as the Ambisonic-format RIR 312) via the neural acoustic field module such as the DANF module 310. Each selected RIR is then convolved with an anechoic audio signal, producing a spatialized Ambisonic audio signal that reflects the acoustic properties of the simulated environment.

The resulting synthesized Ambisonic audio signals 1602 are then provided as input to the neural network 1604, which is configured to perform one or more spatial audio classification or recognition tasks 1608. These one or more spatial audio classification or recognition tasks 1608 may include direction-of-arrival estimation, speech activity detection, acoustic scene classification, speaker localization, or sound event recognition.

By generating a wide variety of labeled spatialized signals across diverse conditions, the audio system 302 enables the creation of robust and scalable training datasets for spatial audio machine learning, supporting both supervised learning and self-supervised representation learning.

Accordingly, FIG. 16 illustrates the audio system 302 for automated training data generation through spatial audio simulation, leveraging Ambisonic rendering and neural modeling to support the development of high-performance audio AI models.

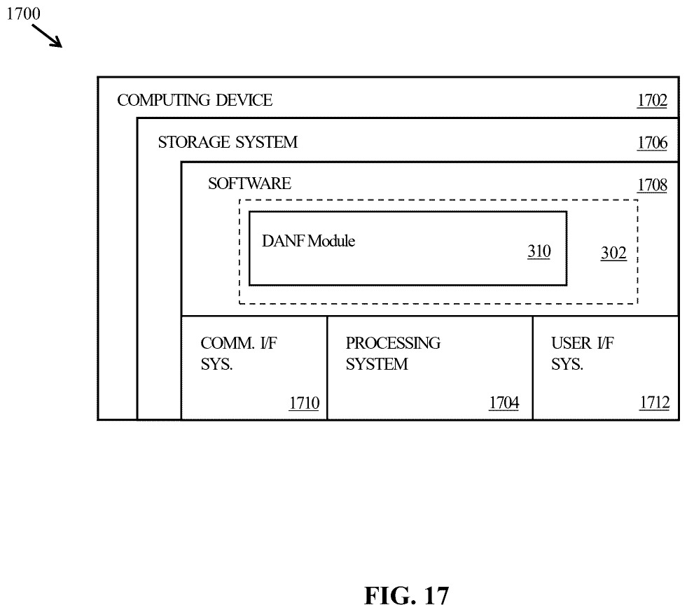

FIG. 17 illustrates a block diagram 1700 of a computing device 1702 that is representative of any system or collection of systems in which the various processes, programs, services, and scenarios disclosed herein may be implemented. The computing device 1702 is used to implement and/or embody the functionalities and operations performed by the audio system 302.

Examples of the computing device 1702 include, but are not limited to, desktop and laptop computers, tablet computers, mobile computers, audio devices, and wearable devices. Examples may also include server computers, web servers, cloud computing platforms, and data center equipment, as well as any other type of physical or virtual server machine, container, and any variation or combination thereof.

The computing device 1702 may be implemented as a single apparatus, system, or device or may be implemented in a distributed manner as multiple apparatuses, systems, or devices. The computing device 1702 includes, but is not limited to, processing system 1704, storage system 1706, software 1708, communication interface system 1710, and user interface system 1712. Processing system 1704 is operatively coupled with storage system 1706, communication interface system 1710, and user interface system 1712.

Processing system 1704 loads and executes software 1708 from storage system 1706. Software 1708 includes and implements direction-aware neural acoustic field for spatially-resolved room impulse response modeling via the DANF module 310, which is representative of audio processes, training process, multi-subject training process, and subject-specific training process. When executed by processing system 1704, software 1708 directs processing system 1704 to operate as described herein for at least the various processes, operational scenarios, and sequences discussed in the foregoing implementations. Computing device 1702 may optionally include additional devices, features, or functionality not discussed for purposes of brevity.

Referring still to FIG. 17, processing system 1704 may comprise a micro-processor and other circuitry that retrieves and executes software 1708 from storage system 1706. Processing system 1704 may be implemented within a single processing device but may also be distributed across multiple processing devices or sub-systems that cooperate in executing program instructions. Examples of processing system 1704 include general purpose central processing units, graphical processing units, digital signal processors, application specific processors, and logic devices, as well as any other type of processing device, combinations, or variations thereof.

Storage system 1706 may comprise any computer readable storage media readable by processing system 1704 and capable of storing software 1708. Storage system 1706 may include volatile and nonvolatile, removable, and non-removable media implemented in any method or technology for storage of information, such as computer readable instructions, data structures, program modules, or other data. Examples of storage system 1706 include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1706 may also include computer readable communication media over which at least some of software 1708 may be communicated internally or externally. Storage system 1706 may be implemented as a single storage device but may also be implemented across multiple storage devices or sub-systems co-located or distributed relative to each other. Storage system 1706 may comprise additional elements, such as a controller, capable of communicating with processing system 1704 or possibly other systems.

Software 1708 includes the audio system 302 which further includes the DANF module 310 for direction-aware neural acoustic field for spatially-resolved room impulse response modeling and may be implemented in program instructions and among other functions may, when executed by processing system 1704, direct processing system 1704 to operate as described with respect to the various operational scenarios, sequences, and processes illustrated herein. For example, software 1708 may include program instructions for implementing the inference and training processes described herein.

In particular, the program instructions may include various components or modules that cooperate or otherwise interact to conduct the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1708 may include additional processes, programs, or components, such as operating system software, virtualization software, or other application software. Software 1708 may also comprise firmware or some other form of machine-readable processing instructions executable by processing system 1704.

In general, software 1708 may, when loaded into processing system 1704 and executed, transform a suitable apparatus, system, or device (of which computing device 1702 is representative) overall from a general-purpose computing system into a special-purpose computing system customized to perform inference and/or training in an optimized manner. Indeed, encoding software 1708 on storage system 1706 may transform the physical structure of storage system 1706. The specific transformation of the physical structure may depend on various factors in different implementations of this description. Examples of such factors may include, but are not limited to, the technology used to implement the storage media of storage system 1706 and whether the computer-storage media are characterized as primary or secondary storage, as well as other factors.

For example, if the computer readable storage media are implemented as semiconductor-based memory, software 1708 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1710 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1702 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

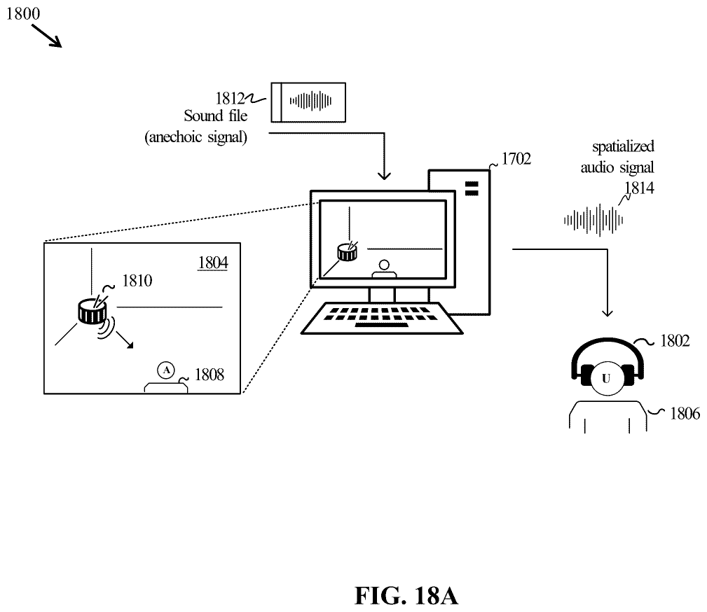

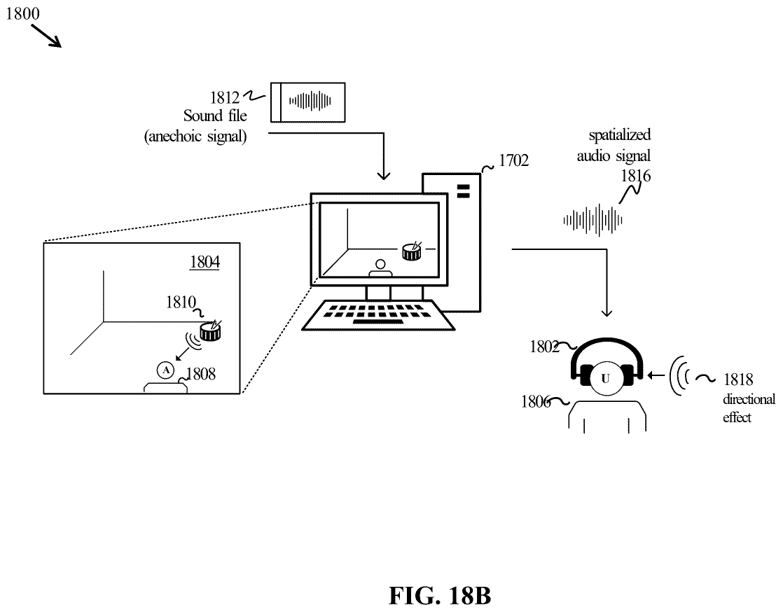

FIG. 18A and FIG. 18B illustrate schematic diagrams showing an operational example 1800 of an audio task performed by the audio system 302, according to an embodiment of the present disclosure. FIG. 18A and FIG. 18B are explained in conjunction with FIG. 11 and FIG. 17. The audio task may be the audio task 1102 performed by the computing device 1702.

Operational example 1800 involves the computing device 1702 and an audio device 1802. Computing device 1702 is representative of a personal computer, server computer, tablet computer, gaming console, mobile phone, wearable device, or any other suitable computing device capable of employing the audio system 302 and executing the DANF module 3100. Audio device 1802 is representative of any device(s) capable of receiving a spatialized audio signal and outputting audible sounds, examples of which include headsets, headphones, and speakers.

In some cases, computing device 1702 and audio device 1802 may be provided in the context of a single device such as virtual/augmented reality goggles or glasses. Alternatively, or in addition, the functionality provided by computing device 1702 may be distributed across multiple computing devices such as in a client-server implementation. In still another alternative, or in addition, some, or all of the functionality of computing device 1702 may be present in audio device 1802. That is, audio device 1802 in some implementations may itself be capable of employing the audio system 302 to execute the DANF module 310.

In the portion of operational example 1800 illustrated in FIG. 18A, computing device 1702 renders a virtual environment 1804 on its screen. In this example, virtual environment 1804 is representative of a gaming or virtual reality environment having a first-person perspective where user 1806 navigates the environment via an avatar 1808 on the screen. The avatar 1808 is generally positioned at the center of the screen and is controlled by the user to navigate the environment. Virtual environment 1804 includes object 1810 positioned apart from avatar 1808 and at a distance. Sounds “emitted by” object 1810 may be produced from sound files used to render virtual environment 1804. For example, sound file 1812 may reside on computing device 1702 such that it can be invoked and processed when triggered by object 1810. The resulting “sounds” are communicated by computing device 1702 via audio signals to audio device 1802, which plays out real, analog sounds for the enjoyment of user 1806.

It is desirable for the real sounds produced by audio device 1802 to sound to user 1806 as-if they are arriving from the same direction as that of object 1810 relative to avatar 1808 in virtual environment 1804. Accordingly, computing device 1702 employs the audio system 302 to determine the sound source direction for sounds emitted by object 1810 with respect to avatar 1808. The virtual direction of the sound is fed by computing device 1702 into a neural network corresponding to the DANF module 310 that outputs spatialized audio signal 1814 of high quality and high fidelity.

Internal to computing device 1702, a software component associated with object 1810 generates an anechoic audio signal from sound file 1812 that, without any modification, would be transmitted to and played out by audio device 1802. The resulting sound would lack the desired directional effect as originating from the front and left of user 1806. However, by employing the audio system 302, computing device 1702 is able to run the anechoic audio signal through the DANF module 310, resulting in the spatialized audio signal 1814. Computing device 1702 then transmits the spatialized audio signal 1814 to audio device 1802.

Audio device 1802 receives and plays out the spatialized audio signal such as by driving speaker components that create sound waves having spatialized characteristics. Spatialized audio signal 1814 may be in a digital or analog format when received from computing device 1702. If in a digital format, audio device 1802 converts the signal to analog and drives an output element based on the analog signal. The spatialized sound, when experienced by user 1806, provides a directional effect of the sound arriving from the front and left of the user.

In FIG. 18B, operational example 1800 continues with the assumption that user 1806 has navigated avatar 1808 to the left of object 1810. Accordingly, the relative position of object 1810 with respect to avatar 1808 has changed, thereby changing the sound source direction. Computing device 1702 inputs the new sound source direction into the neural network to obtain new modal components. The new modal components are then converted to new filter coefficients. The new coefficients cause the DANF module 310 to produce a new spatialized signal 1816 that, when played out audio device 1802, provides a new directional effect 1818. The new directional effect gives user 1806 the sense that the sound is arriving from the front and right at that moment, rather than from the front and left as in FIG. 18A.

In both FIG. 18A and FIG. 18B, spatialized audio is output immediately by computing device 1702 to audio device 1802 because operational example 1800 is intended to illustrate a runtime scenario. However, it may be appreciated that the audio system 302 and the DANF module 310 may be deployed in a pre-processing scenario where spatialized audio is created ahead of time, prior to its download and deployment to either a user computer, an audio device, or both.

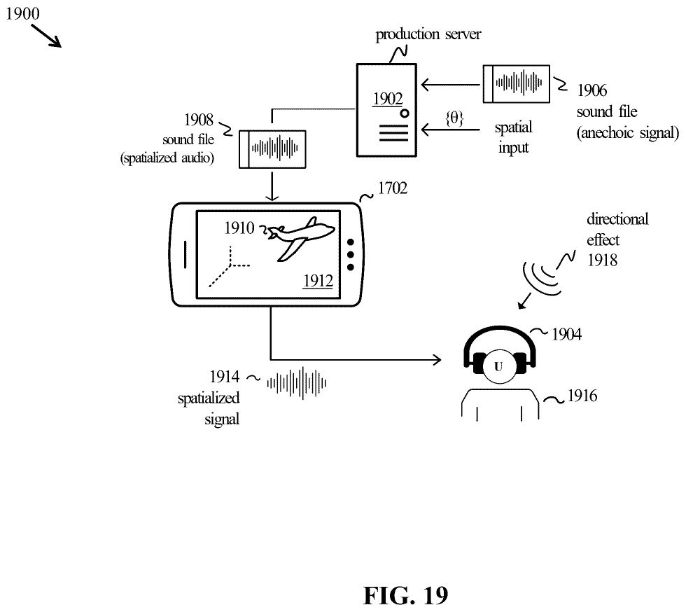

For example, in some implementations, the audio system 302 and the DANF module 310 may be employed in a media production environment to produce spatialized audio for movies, television shows, video games, animated video, video clips, and purely audio-based media that lacks video (e.g., audio books, music, and the like). FIG. 19 illustrates one such example.

FIG. 19 illustrates an operational example 1900 for the audio system 302, according to an embodiment of the present disclosure. FIG. 19 is explained in conjunction with elements from FIG. 11, FIG. 17, FIG. 18A, and FIG. 18B.

In FIG. 19, operational example 1900 involves production server 1902, computing device 1702, and audio device 1904. Production server 1902 is representative of any computer capable of employing the audio system 302 and executing the DANF module 310. Computing device 1702 is representative of any device capable of receiving spatialized audio data and outputting a spatialized audio signal represented in the data. Audio device 1904 is representative of any device(s) capable of receiving a spatialized audio signal and outputting audible sounds, examples of which include headsets, headphones, and speakers. In some cases, computing device 1702 and audio device 1904 may be integrated into a single device such as a smart television with an integrated speaker(s), a mobile phone and its speaker(s), or the like.

In operation, production server 1902 receives anechoic audio 1906. The anechoic audio 1906 may be received as part of a multi-media file or group of files such as a movie, video clip, musical recording, or other such audio sources. In some cases, the anechoic audio 1906 may be received separately from the video. In other cases, the anechoic audio 1906 may be exclusive of any video such as with respect to a song, audio book, and so on.

Production server 1902 also receives or otherwise obtains spatial input data. The spatial input data represents, for example, an assumed listener position at various points in time, thereby allowing production server 1902 to produce spatialized audio data that is synchronized in time with the assumed listener positions. Alternatively, or in addition, the spatial input data may include assumed or annotated positions of sound source objects such as on-screen elements (e.g., a plane in the sky in a movie) or musical instruments (e.g., orchestral instruments positioned differently relative to each other and to an assumed center position of a listener).

Production server 1902 may thus determine a relative position of sound sources to that of a virtual listener at various points in time. For each point in time, or each duration of an acceptable length, production server 1902 determines the Ambisonic format RIR 312 based on a sound source direction at that time (or for that duration of time). Production server 1902 then converts the Ambisonic format RIR 312 to spatialized audio data in an audio file format.

In operational example 1900, it is assumed for illustrative purposes that the virtual listener is positioned to the left of the sound source. For instance, the sound source may be a plane or other such object captured on video generally on the right side of the screen. The sound associated with the plane is therefore associated with a rightward sound source direction relative to a central position of the virtual listener.

Production server 1902 supplies the rightward direction as spatial input to a neural network to obtain the Ambisonic format RIR 312. The audio processing module 308 of the computing device 1702 then converts the Ambisonic format RIR 312 into a spatialized audio signal 1908 which may then be encoded in a sound file.

Production server 1902 provides the spatialized audio data in sound file to computing device 1702 for output by audio device 1904. It may be appreciated that production server 1902 may provide the spatialized audio data indirectly to computing device 1702 such as via one or more networks, through an online distribution channel, or in any other number of ways. Alternatively, or in addition, production server 1902 may provide the spatialized audio data directly to computing device 1702. Similarly, sound file may be provided by production server 1902 as a stand-alone file, as one of several files in a download, in the context of a larger media project such as a movie or video clip, or via any one of numerous delivery formats.

In any case, computing device 1702 receives and stores sound file for retrieval and playback at the appropriate time. For instance, computing device 1702 may retrieve and play sound file at a particular moment in a video game, in the context of a movie or a song, when playing a specific video clip, or whatever the moment may be that involves sound file.

In this example, it is assumed that sound file represents the sound of an object 1910 displayed in media environment 1912 that outputs a familiar sound (e.g., that of a jet flying across the sky). At or around the moment in time that object 1910 is displayed on the screen of computing device 1702, sound file is processed by computing device 1702, resulting in spatialized audio signal 1914. Computing device 1702 transmits spatialized audio signal 1914 to audio device 1904 associated with user 1916.

Audio device 1904 receives spatialized audio signal 1914 and processes it to generate an analog signal that drives the speaker components of the device to generate an audible sound heard by user 1916. The audible sound, due to the spatialized characteristics of the audio signal, provides a directional effect 1918 of the sound coming from the right side of the screen. A similar effect could be provided with respect to orchestral music, for example, providing a user with the effect of some instruments playing to the right of the user, while others play from the left, all of which may be accomplished in a pre-processing environment such as that discussed immediately above with respect to FIG. 18A and FIG. 18B.

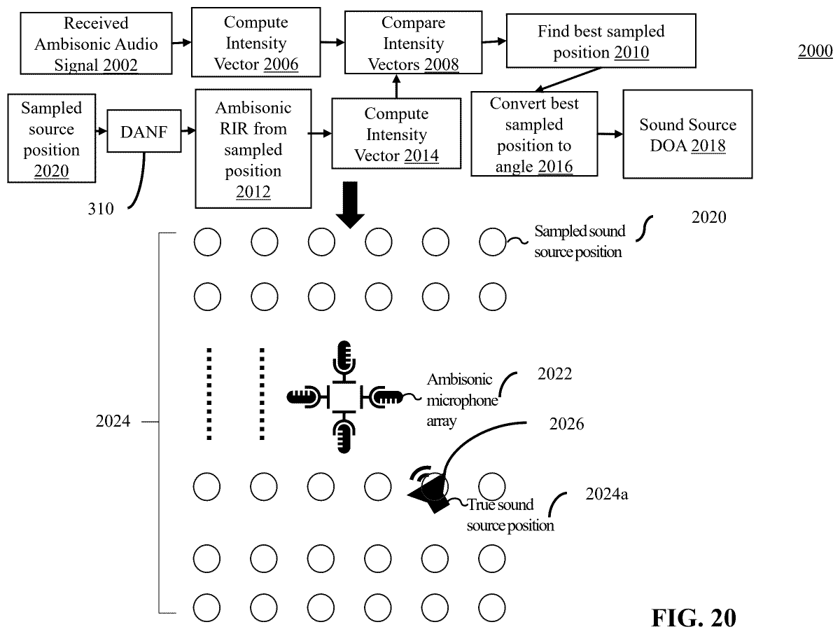

FIG. 20 illustrates a schematic diagram showing an operational example 2000 of an audio task of sound source localization performed by the audio system 302, according to an embodiment of the present disclosure.

The operational example 2000 demonstrates that the DANF module 310 is used when the audio task 304 is sound source localization. To that end, the audio processing module 308 of the audio system 302 includes the DANF module 310 which is configured to perform the audio task 304 of sound source localization.

The audio task 304 of sound source localization may be performed in reverberant environments, where typical beamforming approaches based on time delays between microphones are inaccurate due to reverberation.

In such environments, the operational example 2000 is implemented by sampling a grid of possible sound source positions 2024 to localize a sound source 2026 using an ambisonic microphone array 2022. The true sound source position 2024a needs to be localized to identify DOA of the sound coming from the sound source 2026. The audio processing module 308 includes the DANF module 310, through which the audio processing module determines the known microphone location and each possible source location on the grid of possible sound source positions 2024, to predict an ambisonics RIR at each grid position.

The operational example 2000 receives an ambisonic audio signal 2002 from the ambisonic microphone array 2022 and computes an intensity vector from the recorded sound 2006. The intensity vector is a feature containing the directional information from an ambisonics signal, but there may be errors in the directional information due to reverberation. The DANF module 310 receives a sampled sound source position 2020 from a grid of sampled sound source positions 2024 along with the position of the ambisonics microphone array 2022 and generates an ambisonic RIR corresponding to the sampled sound source position 2020. Next, the audio processing module 308 computes an intensity vector 2014 from the generated RIR at each sampled sound source position and compares 2008 them using a technique such as cosine distance, Euclidean distance, etc. A position on the grid of sampled sound source positions 2024 whose RIR best matches the measured microphone signal that is received 2002, is then used to calculate the DOA for the sound source 2026.

In an embodiment, the operational example 2000 discloses that the audio processing module 308 is configured to compare 2008 the intensity vector for the sampled sound source position 2014 with each of the intensity vectors from the recorded sound 2006 to find a best sampled position 2010. The best sampled position 2010 is then converted to an angle 2016 which is then further used to compute the DOA 2018 of the sound source 2026. By using the ambisonics RIRs generated from the DANF module 310 in estimating the DOA, the system has additional robustness to reverberation compared to classical beamforming-based approaches for DOA estimation.

Further, the localization of the sound source by the audio system 302 may be used in a variety of applications, including, but not limited to, robotic and autonomous navigation, hearing aids, advanced conferencing applications, hearing aids, intrusion detection, surveillance systems, and the like.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching disclosure principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

1. An audio system for performing an audio task based on spatial modeling of audio signals, comprising: a processor; and a memory storing instructions which, when executed by the processor, configure the audio system to perform the audio task using a plurality of software modules, the plurality of software modules comprising:
a direction-aware neural acoustic field module trained to:
receive as input, a spatial configuration indicative of at least: a position of an acoustic source, a position of a listener, and an orientation of the listener within a three-dimensional environment; and
generate, based on the spatial configuration, an Ambisonic-format room impulse response (RIR) comprising a plurality of components indicative of directionally-resolved acoustic energy; and
an audio processing module operatively coupled to the direction-aware neural acoustic field module, the audio processing module being configured to perform the audio task based on the Ambisonic RIR.

2. The audio system of claim 1, wherein the Ambisonic-format RIR comprises a multi-channel RIR encoded using a plurality of spherical harmonic components corresponding to spatially distinct directions.

3. The audio system of claim 2, wherein the Ambisonic format comprises a B-format representation including an omnidirectional channel carrying an omnidirectional signal, and three directional channels carrying directional signals, wherein the directional signals respectively correspond to front-back, left-right, and up-down directional components.

4. The audio system of claim 1, wherein the audio processing module is configured to iteratively produce the spatial configuration during the performance of the audio task.

5. The audio system of claim 1, wherein the direction-aware neural acoustic field module is trained using a loss function based at least in part on an intensity vector computed from the plurality of components of the Ambisonic-format RIR.

6. The audio system of claim 1, wherein the direction-aware neural acoustic field module is further configured to receive, as part of the input, geometric context of the three-dimensional environment.

7. The audio system of claim 6, wherein the geometric context of the three-dimensional environment includes bounce points representing reflective surfaces within the three-dimensional environment.

8. The audio system of claim 1, wherein the neural acoustic field module is adapted to a new environment using a low-rank parameter adaptation process.

9. The audio system of claim 1, wherein the audio processing module is further configured to:
convolve the Ambisonic-format room impulse response with an anechoic audio signal to generate a spatialized Ambisonic audio signal; and
perform the audio task based on the spatialized Ambisonic audio signal.

10. The audio system of claim 9, wherein the audio task comprises rendering a virtual or augmented reality audio scene to a headset of the listener, and wherein the audio processing module is configured to:
decode the spatialized Ambisonic audio signal into a binaural audio signal using a head-related transfer function (HRTF) corresponding to a head orientation of the listener; and
transmit the binaural audio signal to the headset for playback via headphones of the headset.

11. The audio system of claim 10, wherein the audio processing module is configured to update the decoded binaural signal in real time in response to changes in one or a combination of the position of the listener and the orientation of the listener in virtual or augmented reality audio scene, wherein the audio processing module is configured to:
detect the changes the position of the listener and the orientation of the listener to update the spatial configuration;
submit the updated spatial configuration to the neural acoustic field module to update the Ambisonic RIR;
convolve the updated Ambisonic RIR with the anechoic audio signal to update the spatialized Ambisonic audio signal;
decode the updated spatialized Ambisonic audio signal into an updated binaural signal; and
render the updated binaural signal to the headphones of the headset.

12. The audio system of claim 9, wherein the audio task includes a sound source localization, and wherein the audio processing module is configured to
compute a direction-of-arrival (DoA) estimate based on an intensity vector derived from directional components of the spatialized Ambisonic audio signal.

13. The audio system of claim 12, wherein the Ambisonic-format RIR includes an omnidirectional channel carrying an omnidirectional signal, and three directional channels carrying directional signals forming a plurality of directional Ambisonic components, wherein the audio processing module is configured to:
compute a time-frequency representation of the spatialized Ambisonic audio signal using a short-time Fourier transform (STFT);
derive an intensity vector for each time-frequency bin by calculating a real-valued vector whose components correspond to real parts of products of a complex conjugate of an omnidirectional Ambisonic component and each of a plurality of directional Ambisonic components;
aggregate the intensity vectors across a plurality of time-frequency bins to form an averaged intensity vector; and
compute the DoA estimate based on an orientation of the averaged intensity vector relative to a reference coordinate system.

14. The audio system of claim 9, wherein the audio task comprises acoustic scene simulation, and wherein the audio processing module is configured to:
simulate a user-defined sound field within a virtual environment by selecting source-listener positions and generating corresponding spatialized Ambisonic signals using the neural acoustic field module.

15. The audio system of claim 9, wherein the audio task comprises direction-aware speech enhancement or separation, and wherein the audio processing module is configured to:
separate a target speech signal from background noise by identifying a direction of interest from the spatialized Ambisonic audio signal and applying spatial filtering or beamforming techniques centered on the identified direction.

16. The audio system of claim 9, wherein the audio task comprises generating training data for machine learning models, and wherein the audio processing module is configured to:
synthesize spatialized Ambisonic audio signals under varying spatial configurations and acoustic environments,
and provide the synthesized signals as input to a neural network configured for spatial audio classification or recognition tasks.

17. A computer-implemented method for performing an audio task based on spatial modeling of audio signals, comprising:
receiving, as input, a spatial configuration indicative of at least: a position of an acoustic source, a position of a listener, and an orientation of the listener within a three-dimensional environment;
generating, based on the spatial configuration, an Ambisonic-format room impulse response (RIR) comprising a plurality of components indicative of directionally-resolved acoustic energy; and
performing the audio task based on the Ambisonic RIR.

18. The computer-implemented method of claim 17, wherein the Ambisonic-format RIR comprises a multi-channel RIR encoded using a plurality of spherical harmonic components corresponding to spatially distinct directions.

19. The computer-implemented method of claim 18, wherein the Ambisonic format comprises a B-format representation including an omnidirectional channel carrying an omnidirectional signal, and three directional channels carrying directional signals, wherein the directional signals respectively correspond to front-back, left-right, and up-down directional components.

20. The computer-implemented method of claim 17, further comprising executing a training operation, the training operation comprising computing a loss function based at least in part on an intensity vector computed from the plurality of components of the Ambisonic RIR, where the intensity vector computed from the true Ambisonic RIR in the training data is compared to the intensity vector computed from the generated Ambisonic RIR.
